(19) United States
(12) Patent Application Publication
(10) Pub. No.: US 2026/0222219 A1
(43) Pub. Date: Jul. 30, 2026

(54) Real-Time Agile Machine Cryptography Based on Reversible N-state Inverters

(71) Applicant: Peter Lablans, Morris Township, NJ (US)

(72) Inventor: Peter Lablans, Morris Township, NJ (US)

(21) Appl. No.: 19/574,403

(22) Filed: Mar. 22, 2026

Related U.S. Application Data
(63) Continuation-in-part of application No. 19/364,687, filed on Oct. 21, 2025.
Application No. 19/364,687 is a continuation-in-part of application No. 19/076,781, filed on Mar. 11, 2025, now Pat. No. 12,476,789.
Application No. 19/076,781 is a continuation-in-part of application No. 18/741,663, filed on Jun. 12, 2024.
(63) Continuation-in-part of application No. 18/750,970, filed on Jun. 21, 2024, now Pat. No. 12,609,809.
(63) Continuation-in-part of application No. 18/908,321, filed on Oct. 7, 2024.
(60) Provisional application No. 63/524,125, filed on Jun. 29, 2023.
(60) Provisional application No. 63/548,184, filed on Nov. 11, 2023.
(60) Provisional application No. 63/573,331, filed on Apr. 2, 2024.
(60) Provisional application No. 63/726,453, filed on Nov. 29, 2024.
(60) Provisional application No. 63/747,282, filed on Jan. 20, 2025.
(60) Provisional application No. 63/973,561, filed on Feb. 1, 2026.

(51) Int. Cl. H04L 9/32; H04L 9/08; H04L 9/30

(52) U.S. Cl. CPC H04L 9/3236; H04L 9/0825; H04L 9/30; H04L 9/3247

(57) ABSTRACT

Data is processed by cryptographic operations selected from encryption, decryption and hashing. N-state data elements with n an integer at least greater than 2 are processed based on an n-state reversible n-state inverter, which has an equivalent complete size of k1 bits and is derived from a sequence of data elements with an equivalent size of k2 bits with k1>k2. The sequence of data elements is preferably secret data, shared by at least 2 computing devices. The derived n-state reversible inverter may be a self-propagating n-state inverter generating different n-state reversible inverters. It may be generated by extending a shared key, by implementing a Feedback Shift Register, by an array vector multiplication, and/or by a radix-n transformation. A generated n-state reversible inverter is applied in a Finite Lab Transform of a 2-operand n-state computer function, including a 2-operand commutative involution not characterizable as an addition over a finite field.

### CROSS-REFERENCE TO RELATED APPLICATIONS

This application is a continuation-in-part of and claims the benefit of U.S. patent application Ser. No. 19/364,687 filed on Oct. 21, 2025. U.S. patent application Ser. No. 19/364,687 is a continuation-in-part of and claims the benefit of U.S. patent application Ser. No. 19/076,781 filed on Mar. 11, 2025. Application Ser. No. 19/076,781 is a continuation-in-part of and claims the benefit of U.S. patent application Ser. No. 18/741,663 filed on Jun. 12, 2024. U.S. patent application Ser. No. 19/076,781 claims the benefit of U.S. Provisional Application 63/747,282 filed on Jan. 20, 2025. U.S. patent application Ser. No. 19/076,781 claims the benefit of U.S. Provisional Application 63/726,453 filed on Nov. 29, 2024. U.S. patent application Ser. No. 19/076,781 claims the benefit of U.S. Provisional Application 63/573,331 filed on Apr. 2, 2024. This application is a continuation-in-part of and claims the benefit of U.S. patent application Ser. No. 18/750,970 filed on Jun. 21, 2024. U.S. patent application Ser. No. 18/750,970 claims the benefit of U.S. Provisional Application 63/524,125 filed on Jun. 29, 2023. This application is a continuation-in-part of and claims the benefit of U.S. patent application Ser. No. 18/908,321 filed on Oct. 7, 2024. U.S. patent application Ser. No. 18/908,321 claims the benefits of U.S. Provisional Application 63/663,456 filed on Feb. 14, 2024. U.S. patent application Ser. No. 18/908,321 claims the benefit of U.S. Provisional Application 63/548,184 filed on Nov. 11, 2023. This application claims the benefit of U.S. Provisional Application 63/973,561 filed on Feb. 1, 2026. All of the above cases and applications mentioned above are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Machine or computer implemented cryptography is nowadays essential for securely exchanging data over the Internet. But data, either in transit over networks and/or stored on what may be called In-Cloud servers at rest, is subject to almost continuous attacks and especially theft by malfeasants, including by state sponsored attackers, who may have almost unlimited means to attack and/or try to decrypt confidential data. While intrusion detection and prevention are important, certain detected Advanced Persistent Threats (APTs) seem unavoidable. In that context secure (unbreakable) encryption is important.

Commonly, standard cryptographic methods and primitives are used. These include encryption such as AES, AES-CTR, AES-GCM, ChaCha20 and versions thereof, hashing methods such as SHA256/512m SHA-3 for authentication as well as digital signature schemes such as DSA, RSA, EdDSA, ECDSA, Pairing Based Signatures, Schnorr digital signature, Dilithium, SPHINCS+ and others.

Future Quantum Computers (“QC”) are believed to form a threat to current machine cryptography, especially as it relates to Public Key Infrastructure (“PKI”) key establishment. At the time of the current submission, it appears that there is unshaken belief in security of current cryptographic primitives. This relates, for instance, to primitives in symmetric encryption, such as AES and its different modes, and ChaCha20. However, AES is already over 25 years old. Its original version, Rijndael is from 1998. While still going strong, a 25 year life-span of an encryption being unbroken is unusual. Empirically, it is unlikely that AES remains unbroken for the next decade. Under threat of Harvest Now, Decrypt Later it is prudent to prepare right now with drop-in more secure solutions for symmetric encryption. Such proven solutions currently are scarce.

For at least the above reasons, methods and devices are required that improve security of current machine cryptography for symmetric encryption, hashing, validation, authentication and signatures at sufficient levels that will successfully resist breaking, man-in-the-middle and other attacks, without substantially adversely affecting computer performance.

### SUMMARY OF THE INVENTION

In accordance with an aspect of the present invention a computing device is provided, comprising: a memory configured to store data including instructions; an input enabled to receive external cryptographic data generated by a transmitting computer device over a physical transmission channel; a processor enabled to retrieve instructions from the memory and to execute the instructions to perform the one or more steps of: implementing an n-state reversible inverter derived from the received external cryptographic data, with n an integer greater than 3; processing at least part of the cryptographic data with a cryptographic operation selected from the group consisting of a decryption, a hashing, a sequence generation, wherein the cryptographic operation includes an n-state computer operation based on the n-state reversible inverter; and generating data, derived from at least part of the received external cryptographic data, and the data being selected from the group consisting of decrypted data, a hash, a shared PKI key, and a verification of a digital signature.

In accordance with a further aspect of the present invention, the computing device is provided, wherein the external cryptographic data includes Public Key Infrastructure (PKI) data.

In accordance with yet a further aspect of the present invention, the computing device is provided, wherein the n-state reversible inverter is generated derived from a Public Key Infrastructure (PKI) key, shared with a sending computer.

In accordance with yet a further aspect of the present invention, the computing device is provided, wherein the n-state reversible inverter is applied in a Finite Lab Transform of a computer function that has at least 2 input operands.

In accordance with yet a further aspect of the present invention, the computing device is provided, wherein the n-state reversible inverter is implemented in an n-state array-vector multiplication derived from an n-state Maximum Length (ML) Feedback Shift Register (FSR).

In accordance with yet a further aspect of the present invention, the computing device is provided, wherein the n-state computer operation is a 2 operand operation, each operand being represented by a word of two or more n-state elements and the n-state computer operation includes an n-state reversible residue function and an n-state transition function and the n-state transition function is configured to switch between at least three distinct states.

In accordance with yet a further aspect of the present invention, the computing device is provided, wherein the n-state reversible inverter is based on a p by p array of k-state elements and k\hat{ }p=n with k and p integers and k greater than 3 and p greater than 1.

In accordance with yet a further aspect of the present invention, the computing device is provided, wherein the n-state reversible inverter is based on a p by p array of k-state elements and n is prime with n=k\hat{ }p+q with k, p and q integers and k greater than 3, p greater than 1 and q at least 1.

In accordance with yet a further aspect of the present invention, the computing device is provided, wherein the elements of the p by p array of k-state elements are selected from a shared Private Key Infrastructure (PKI) key.

In accordance with another aspect of the present invention, a computer implemented cryptographic method is provided, comprising: receiving by the computer from a physical transmission channel external cryptographic data; implementing by a processor an n-state reversible inverter derived from the external cryptographic data, with n an integer greater than 3; processing by the processor at least part of the external cryptographic data with a computer implemented cryptographic operation selected from the group consisting of a decryption, a hashing, a sequence generation, wherein the cryptographic operation includes an n-state computer operation based on the n-state reversible inverter; and generating data, derived from at least part of the external cryptographic data, and the data being selected from the group consisting of decrypted data, a hash, a shared PKI key, and a verification of a digital signature.

In accordance with another aspect of the present invention, a computer implemented cryptographic method is provided, comprising: receiving by the computer from a physical transmission channel external cryptographic data; implementing by a processor an n-state reversible inverter derived from the external cryptographic data, with n an integer greater than 3; processing by the processor at least part of the external cryptographic data with a computer implemented cryptographic operation selected from the group consisting of a decryption, a hashing, a sequence generation, wherein the cryptographic operation includes an n-state computer operation based on the n-state reversible inverter; and generating data, derived from at least part of the external cryptographic data, and the data being selected from the group consisting of decrypted data, a hash, a shared PKI key, and a verification of a digital signature.

In accordance with yet another aspect of the present invention, the computer implemented cryptographic method is provided, wherein the external cryptographic data includes Public Key Infrastructure (PKI) data.

In accordance with yet another aspect of the present invention, the computer implemented cryptographic method is provided, wherein the n-state reversible inverter is generated derived from a Public Key Infrastructure (PKI) key, shared with a sending computer.

In accordance with yet another aspect of the present invention, the computer implemented cryptographic method is provided, wherein the n-state computer operation is an n-state 2-operand commutative involution with n=2\hat{ }k and the n-state computer operation is not characterizable as an addition over finite field GF(n=2\hat{ }k) with k an integer greater than 1.

In accordance with yet another aspect of the present invention, the computer implemented cryptographic method is provided, wherein the n-state reversible inverter is applied in a Finite Lab Transform of a computer function that has at least 2 input operands.

In accordance with yet another aspect of the present invention, the computer implemented cryptographic method is provided, wherein the n-state reversible inverter is implemented in an n-state array-vector multiplication derived from an n-state Maximum Length (ML) Feedback Shift Register (FSR).

In accordance with yet another aspect of the present invention, the computer implemented cryptographic method is provided, wherein the n-state computer operation is a 2 operand operation, each operand being represented by a word of two or more n-state elements and the n-state computer operation includes an n-state reversible residue function and an n-state transition function and the n-state transition function is enabled to assume at least 1 of 3 states.

In accordance with yet another aspect of the present invention, the computer implemented cryptographic method is provided, wherein the n-state reversible inverter is based on a p by p array of k-state elements and k\hat{ }p=n with k and p integers and k greater than 3 and p greater than 1.

In accordance with yet another aspect of the present invention, the computer implemented cryptographic method is provided, wherein the n-state reversible inverter is based on a p by p array of k-state elements and n is prime with n=k\hat{ }p+q with k, p and q integers and k greater than 3, p greater than 1 and q at least 1.

In accordance with yet another aspect of the present invention, the computer implemented cryptographic method is provided, wherein the elements of the p by p array of k-state elements are selected from a shared Private Key Infrastructure (PKI) key.

### BRIEF DESCRIPTION OF DRAWINGS

FIG. 1 is a diagram of a device that modifies a switching operation in accordance with one or more aspects of the present invention;

FIG. 2 is a screenshot of a Matlab program in accordance with one or more aspects of the present invention;

FIGS. 3 and 4 are screenshots of computer implemented lookup tables in accordance with one of more aspects of the present invention;

FIG. 5 is a diagram of an n-state Feedback Shift Register (FSR) in accordance with one of more aspects of the present invention;

FIGS. 6 and 7 illustrate transition tables of different FSRs;

FIG. 8 is a diagram of an n-state Feedback Shift Register (FSR) in accordance with one of more aspects of the present invention;

FIGS. 9 and 10 illustrate transition tables of yet different FSRs;

FIG. 11 is a screenshot of a Matlab program in accordance with one or more aspects of the present invention;

FIG. 12 is a flow diagram of computer implemented steps in accordance with one or more aspects of the present invention;

FIG. 13 is a screenshot of a Matlab program in accordance with one or more aspects of the present invention;

FIG. 14 are screenshots of computerized lookup tables generated by a computer in accordance with one or more aspects of the present invention;

FIGS. 15 and 16 are screenshots of computerized lookup tables generated by a computer in accordance with one or more aspects of the present invention;

FIGS. 17 and 18 illustrate radix-n operations in accordance with one or more aspects of the present invention;

FIGS. 19, 20 and 21 are screenshots of computerized lookup tables generated by a computer in accordance with one or more aspects of the present invention;

FIGS. 22 and 23 are screenshots of Matlab programs in accordance with one or more aspects of the present invention;

FIG. 24 illustrate a generic radix-n operation in accordance with one or more aspects of the present invention;

FIG. 25 is a flow diagram of a radix-n operation in accordance with one or more aspects of the present invention;

FIG. 26 is an illustrative diagram of a computing device; and

FIG. 27 is a diagram illustrating a network.

### DETAILED DESCRIPTION OF THE INVENTION

A computer is a switching machine. It has devices that switch through two or more states in accordance with a pre-established pattern. These patterns are commonly described as two-operand logic functions like XOR, AND, OR, NAND, or other binary logic functions. The logic function states are often described as numbers such as 0 and 1. However, there are no actual 0s and is inside a device. The 0s and is are symbolic descriptions by humans of the physical states of a switching machine.

In modern computer machinery, the binary states of switching devices are technically indicated by being either LOW or HIGH. What LOW and HIGH mean depends on the applied technology. In TTL switching devices, a LOW voltage may be between 0V and 0.8V, and a HIGH voltage may be between 2V and 5V. In standard CMOS devices, a LOW voltage may be between 0V and 1.5V, and a HIGH voltage may be between 3.5V and 5V. One may assign the logic value 0 to a LOW voltage and the logic value 1 to a HIGH voltage, but the reverse is also known.

Dr. Gerrit Blaauw was the inventor's professor in computer design. He explains that a computer design is described at a hierarchy of three levels: 1) the architecture, disclosing (to the system programmer) what the device does, 2) the implementation or logic, a functional (logic) description of how the function is realized by available functional components, and 3) the physical realization of real components that realize a functional requirement. The books Gerrit A. Blaauw, Digital System Implementation, Prentice-Hall, 1976, and Blaauw and Brooks, Computer architecture: concepts and evolution, Addison-Wesley, 1997, are both incorporated herein by reference, use executable APL instructions to create digital circuitry. The significance of executable code like APL or Matlab or others is that it establishes a true physical realization. That is, the instructions, when executed, are not merely an abstract idea or a description; they establish a real-life physical circuit. While one may observe the description of a design of this circuitry in terms of functional expressions, they represent an actual physical circuit.

A common understanding of what a computer does and how it does it seems to have diminished, as computers are so ubiquitous and anthropomorphistic description of computers are rampant. However, review of the original MIT Master Thesis of Claude Shannon in 1938 entitled “A Symbolic Analysis of Relay and Switching Circuits, reminds that symbolic representation of states was applied to facilitate circuit design. Internally, even in Shannon, no numbers exist inside a circuit. In Shannon circuit states (relays impedance or “hindrance” as Shannon calls it) are provided with an external label. These labels of course do not exist physically in the circuits.

Aspects of the invention disclosed herein, while for convenience sometimes described in terms of mathematical looking expressions and numerical states, are directed toward physical structures and require devices like configurable processors and memories and the like, and are not directed to an abstract idea. They all realize physical structures that have causal physical states. While in general programmable processors are built from active electronic devices, one could also replace them with addressable memory devices that store the required truth table. This may be applied in Read-Only-Memory (ROM) and in devices such as Programmable Logic Devices (PLDs) and Field Programmable Gate Arrays (FPGAs) as well as programmable processors, GPUs and multi-core processors

One of ordinary skill in the art of computing devices knows that these devices are physical devices. The storing of a lookup table is a physical process, and no “numbers” are stored. Only physical states are created. One reason to point out these well-known facts here is that some people, generally not well-versed in computer design and/or realization, often believe that computers process numbers. But as explained above and well-known in the engineering literature, computers and processors do not do such a thing. The appearance of number symbols occurs by apparatus that make it appear that numbers are inputted or displayed. For instance, when hitting a key 8 on a computer keyboard, a signal is generated that may be represented by a number 8. Similarly, when a computer display shows a number 8, it is the activation of light-emitting elements by a computer-generated signal that lights up as 8 on the display. Internally a computer applies binary L/H signals. Conversions of output signals to display numbers and key input to signals are well-known, but not always recognized.

Switching operations may be described in terms of Boolean algebra or other mathematical terms. For instance, a bitwise XORing of words of 8 bits may be described as an addition over GF(256). But this is merely the description. In effect, the computer does not perform an addition over GF(256) as those concepts do not exist inside a computer. Still, for functional description, the use of addition over GF(256) is appropriate. But it goes with the understanding that this is merely a functional description of an operation. It is the logic implementation equivalent, in the sense of the teachings of Blaauw, of a physical realization. This applies for all descriptions of operations following herein. This means that when an operation or function, even when described by a mathematical term or by a lookup table, is programmed on a computer and generates an expected and/or valid result, then as taught by Blaauw, there is a physical realization, and the description herein is directed to a device herein and not to an abstract idea.

In that sense, a computer function herein, such as an addition modulo-n, for instance, is not merely a functional description. It corresponds to a structured physical device that performs in accordance with one or more logic operations that may be represented by the function addition modulo-n. The actual structure may, for instance, be a carry ripple adder structure in an Arithmetic Logic Unit (ALU) of a processor.

It would be tiresome and very hard to understand if computing functionality and devices were to be explained on a component schematic level. For the reason of simplicity and transparency, mathematical and functional terms are used with the understanding that a physical structure for doing the function exists or will be configured by instructions in the processor or device. For that reason, all functional and mathematical terms used herein are a (high level) description of a physical structure in a processor or switching device. But without exception herein a computer function is a physical device. One may check this with for instance electrical probes to determine a physical state of an input or output of a device. Thus, the term function herein explicitly and verifiably is a term that is equivalent to a physical device, be it a memory or a combinational circuit or a combination thereof.

### State

The term state is used herein. A state is a label for a physical state. A state may be formed by a combination of physical states. Especially devices disclosed herein process or have states that are determined by 2 or more bits, or word of bits. Processing as disclosed herein may operate on words of bits. As such a state of a device or input or output may be characterized by a word of bits. Herein, rather than using words of bits an n-state means one of n states with n>2 and may be represented (for instance) by its decimal value. One is reminded that the device does not inherently interpret semantic values and one may assign any symbol to an n-state. For convenience states herein are provided herein as either {0, 1, 2, . . . , n−1} is origin 0 or {1, 2, 3, . . . , n} in origin 1.

### N-State Inverter

A device called an inverter or binary inverter is known. It reverses the state of a binary input. It can be described as inv2(x)=[2 1]. When x is selected from {1,2} it provided inv2(1)=2 and inv2(2)=1. In the context of the earlier mentioned Blaauw framework this may be considered an implementation. As an executable Matlab statement for instance, it is of course also a physical device. It may be realized as a combinational circuit or stored in a memory or a combination thereof.

When one types inv2(1) then Matlab responds with 2. The fact that the response is generated proves that a machine exists. While not commonly used one may provide other binary inverters: inv2a(x)=[1 2](identity); inv2b(x)=[1 1](always off) and inv2c(x)=[2 2](always on).

In a similar way an n-state inverter is represented as a sequence of n-state elements. For instance a 4-state inverter may be represented as inv4(x)=[2 3 1 4] with x selected from {1, 2, 3, 4}. In an n-state inverter there are n-possible input and n-possible output states. One may represent the n-state inverter as a sequence of n labels each label having a state or label and a position. For convenience herein a position ‘i’ (the index) represents the input state, and the label on the position ‘i’ in the sequence represent the output state. In general, one prefers for keeping oversight that position in a sequence and input state correspond, so computer programs may use very simple “n-state inverter” statements. One has to take into account the indexing system. Matlab uses indices starting at 1 (origin-1) for arrays: so inv4(2) above would generate output 3. Other system like the computer language C, for instance) uses origin-0 and inv4(2) would generate (if it accepts that notation) the output 1. One is reminded that this is all a matter of representation. If/when an output is generated by a computer instruction, one is dealing with a physical device.

No upward limit is imposed herein on the size of n and n-state inverters, besides practical limitations, which will be dealt with further below. For practical illustrative purposes smaller value of n are use (like n=4 or n=8 or n=16). Matlab and C and other computer languages handle large arrays and vectors easily. Practical n=256 is a popular size in cryptography, as it represents a byte. Another example is a state represented by 32-bits which is 4 bytes or if one so desires n=4,294,967,295 which is of course impractical in most explanations and stretched memory resources for storage.

A concept that is used herein, is the reversible n-state inverter. This is a device that is described by a bijection: a series of n different labels each having one of n positions in the sequence. The reversible aspect of a bijection may be expressed as: an n-state reversible inverter invn(x) is described as a series of n different states in n different positions in the sequence so that invn(x)=y and a corresponding inverter rinv(x) exists so that rinvn(y)=x and invn(rinvn(x))=x.

An n-state inverter herein is a one-operand switching device, wherein an input has one of n different states, with n is preferable an integer 2 or greater, more preferably an integer of 16 or greater. An n-state inverter generates an n-state output, having one of n possible states. An n state element may be a representation of one or more signals able to assume one of n possible states or values. For instance, a word of 8 bits or byte, when all bits can vary may be represented as a 256-state element.

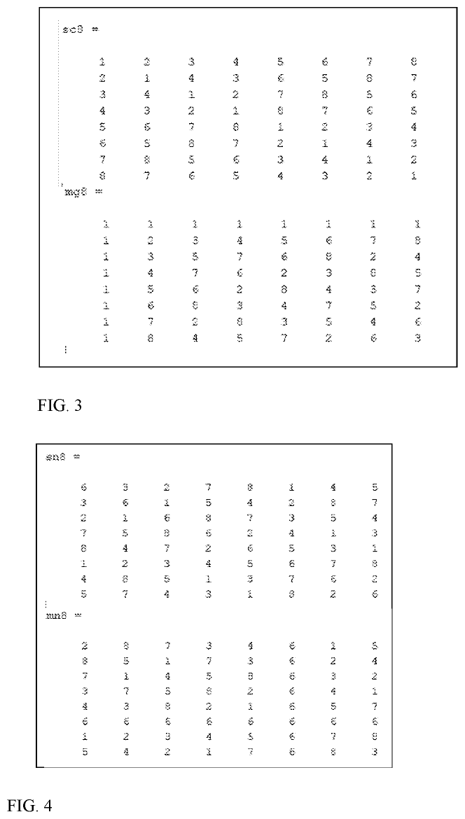

The n-state inverter may be represented as a one operand computer operation. Two-operand n-state operations such as addition modulo-n and addition over GF(n) may be represented by an n by n array of n state elements wherein a row index determines a first operand and a column index the second operand. One may design an actual combinational circuit for n-state (at least) 2 n-state operand functions by known methods such a Karnaugh diagrams. Or one may store them as a Look Up Table in and addressable memory. For instance, an 8-state lookup table that is stored in memory and is accessed by Matlab as sc8 is shown in Matlab screenshot in FIG. 3. One can see that for instance sc8(4,4) with index origin-1 will generate 1.

### The FLT

The Finite Lab-Transform (FLT) was invented and described for instance in U.S. patent Ser. No. 11/336,425 to Peter Lablans issued on May 17, 2022 which is incorporated herein by reference. The FLT requires an n-state reversible inverter (invn), its reversing n-state inverter (rinvn), so that the two inverters in combination provide identity or: invn(rinvn(x))=x and rinv(invn(x))=x for all x being n-state elements, and a 2-operand n-state function. An n-state reversible inverter may be represented by a sequence of n different n-state elements, each n-state element having a position in the sequence an n-state designator often called value. In computer implementation it may be stored as an 1D array such as “invn.” For instance an 8-state reversible inverter may be inv8=[2 3 4 5 6 7 8 1]. Positioning of the 8-state elements is by origin-1 in Matlab. That is the first position in the sequence has index 1 and the final element has position 8. This is in variance with other representations where a first position has index 0 or origin-0. In that case the element indicators are usually selected from {0, 1, 2, . . . , n−1}. A n-state reversible inverter has a reversing inverter ‘rinvn.’ A property of a combination of n-state reversible inverter and reversing inverter is that rinvn(invn(x))=x.

The FLT works as follows: call the input operands a and b (which are preferably represented as n-state operands) and the 2-operand function is fun(a,b) with c=fun(a,b). The input operands are inverted with n-state reversible inverter invn, then the inverted operands are applied in operation fun and the result of this operation is reversed inverted with rinvn. Or according to expressions: ai=invn(a); bi=invn(b); c=fun(ai,bi); and out is out=rinvn(c) or out=rinvn(fun(ai,bi)) or out=rinvn(fun(invn(a),invn(b))). One may also determine out=funflt(a,b). The function funfit is then a modified switching table of switching table fun. One may determine funfit LUT (look-up table) by running through all possible n-state input operands and applying a LUT for invn and rinvn. This has been done for instance for LUTs representing addition over GF(256) that are FLTed. Such a table requires a memory of 65 Kbyte. By itself not very small, but in the context of available memory in current computing devices negligible in size.

The FLT either as apparatus or as method implemented on an apparatus or computer is illustrated in FIG. 1. A device 100 performs an n-state 2 operand operation, like an addition over GF(n), for instance implemented as a bitwise XOR of words of k bits so n=2\hat{ }k. Device 100 has two inputs: 105 and 106 to receive the n-state operands, each operand is inverted by n-state inverter 101 and 102, respectively before entered upon inputs 108 and 109, respectively. FLT inverters 101 and 102 are preferably identical. The device may optionally have a signal input 112, for a signal to enable or start execution of operation 100. The resulting n-state output signal is provided on 110. This n-state signal is then inverted by reversing inverter 103. If one calls 101 inverter ‘invn’ then 103 may be called ‘rinvn” and invn(rinvn(x))=x indicating that the combination of invn and rinvn is identity. The resulting (and FLTed) signal is provided on output 107. The FLT is generally meta-properties preserving. That is, if 100 is characterized as an addition over GF(n) then the FLTed operation is also an addition over GF(n). Even though the numerical representation may be modified. One may use all elements as separate look-up tables. One may also represent the operation between inputs 105 and 106 and output 107, as its own lookup table as for instance an n by n n-state table. While the FLT is illustrated in a 2-operand example, the FLT may be applied to any p-dimensional operation or p-operand operation.

There are different ways to perform an FLT. One such way is to modify the rows and columns of the switching table in accordance with the n-state inverter at the input of the operation to generate an intervening table. Then apply the reversing inverter to the states of the intervening table. This may be a table-based transformation rather than individual state transformation. However, the resulting function is identical.

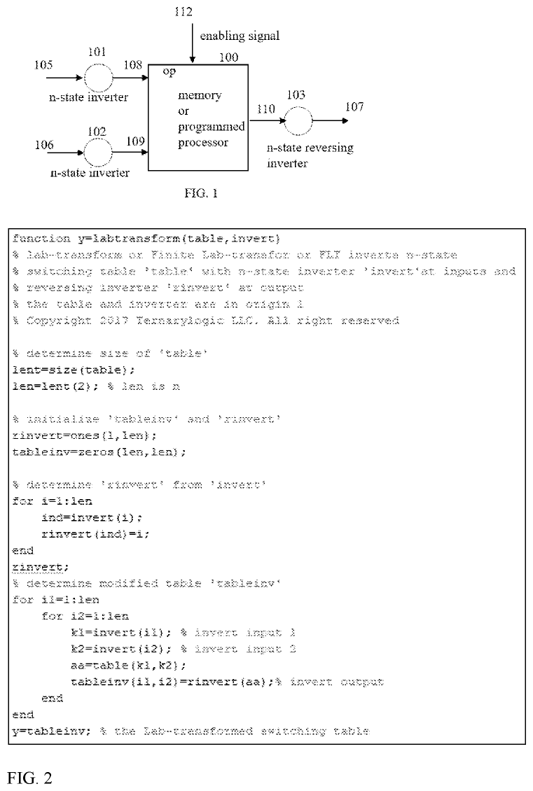

FIG. 2 shows a screenshot of a working Matlab program that performs the FLT. FIG. 3 is a screenshot of tables of an 8-state addition over GF(8) and a related multiplication over GF(8) establishing a finite field GF(8) in origin-1. FIG. 4 is a screenshot of the tables realized with the FLT program of FIG. 2 to output an FLTed-version of the addition and multiplication as shown in FIG. 3. One may notice in FIG. 4 is table sn8 the column/row with index 6 being identity and columns/row 6 in mn8 in FIG. 4 having the same states (now 6 being the zero-element).

The FLT may be applied to a single n-state function, such as an addition over GF(n). A finite field GF(n) is determined by its 2 Laws of Composition, usually called the addition and multiplication over GF(n). These in combination comply with the known axioms of a finite field. One may apply an FLT to for instance the addition over GF(n) and leave the multiplication over GF(n) unchanged. The combination of transformed addition and untransformed multiplication, may not comply longer with these axioms. However, FLTing both functions with the same FLT preserves the compliance with the axioms of a finite field.

The FLT has been applied by the inventor in cryptographic programs in Matlab and Python and C as lookup tables and the use of LUTs actually makes the machine execution if not faster at least not slower than application of standard and unchanged functions. This has been done in applications such as SHA-256, AES-GCM, AES-CTR and other AES modes, ChaCha20 as described on website lcip.in. The FLT requires both the n-state inverter and the corresponding n-state reversing inverter to be performed. One may do this FLT in real-time, using a rule based or an LUT set of inverters, or one may do this off-line and compute the condensed look-up switching table funflt and store it for later use. Again, for smaller values of n like n=256 up to perhaps n=4096 one can create LUTs. However, for much larger n like n being represented by 256 bits for instance, creating and storing an LUT is infeasible. In that case the FLT has to be applied with its components, and as a rule. That is: inverting operands, then processing the inverted operands with the operation and reverse inverting the result.

For consistency and clarity, the inverters for the input operands are called the n-state reversible inverters and the inverter at the output is called the reversing inverter.

An n-state inverter may be stored in a look-up table. But it may also be programmed as a rule or an expression. For instance, one may have as inversion rule based on: invn(x)=xi=d*x+h modulo−n. The inversing inverter rule is then x=(xi−h)*d\hat{ }−1 modulo−n, with x, xi, d and h all being n-state elements. The factor d\hat{ }−1 may be computed using the Extended Euler Algorithm (EEA). One may make more complicated rules. For instance, one may divide the range of generated inversions in 2 equal parts and interleave the parts in a reversible way. This disturbs any linearity that existed.

One may desire to do an FLT of a large function like an addition over GF(2\hat{ }32). The function itself is a bitwise XOR or words of 32-bits. The number 2\hat{ }32 is about 4 billion. A 2\hat{ }32 state inverter would require generating as well as storing 4*2\hat{ }32 bytes or about 16 GBytes. And one would need to do the same for the reversing 2\hat{ }32 state inverter. While not impossible, it would consume much of available storage space and RAM even in desktop computers. The operation of XORing words of 32 bits is very fast as this may happen by parallel processing.

### Rule Based Inversion

The above provided method of individual element inversion and reverse inversion is very fast. Suppose one wants to do y=sn32 bits(x1,x2) wherein x1 and x2 are 32-bit operands and sn32 bits is the FLT of sc32 bits which is the XORing of 32 bits words. Storing a 2\hat{ }32-state inverter pre-determined in a memory is inefficient or at least would require a very large memory and is unpractical. An alternative is to create a rule-based n-state inverter. A rule-based n-state inverter is a computer implemented procedure that based on the input of an n-state operand generates an n-state output. The speed of the inverter is determined by a complexity of instructions to generate an output. Presumably, the number of instructions may be significant and the time to execute the instructions may require multiple clock cycles. However, overall the size of the operands (or the size of n) is not a real limitation. For instance, in Matlab, one may activate ‘biginteger’ computation up to 64 bits with the “uint_n” format. A basically unlimited size of operands is provided by the VPI mode application for big integers in Matlab. Most popular computer languages have big integer facilities.

This indicates that a rule that creates an n-state reversible inverter may be applied to almost any desired word length that represents an n-state element.

An n-state inversion by a feedback shift register or FSR is explained in U.S. patent application Ser. No. 18/741,663 to Lablans, filed on Jun. 12, 2024 which is incorporated herein by reference. The FSR method allows inversions of very large words of bits, for instance of 800 bits. An inversion is then a number of s shifts of the FSR and a reverse inversion is the running of an FSR in its reverse direction. The operand is a content of the shift register. Thus, a fast and simple 32-bit inverter may be realized with a 256-state maximum length FSR with a shift register of 4 256-state (8 bit) elements. The coefficients of the maximum length FSR may be determined using known functionality in Magma Calculator to generate a irreducible polynomial over GF(256) of degree 4.

One may implement a canonical n-state transition matrix A of an ML-FSR determined by a primitive polynomial of degree k over a finite field GF(n) being an FSR with k n-state shift register elements in an array-vector multiplication [y1 y2 . . . yk]=A*[x1 x2 . . . xk]. One may consider the words [y1 y2 . . . yk] and [x1 x2 . . . xk] as each representing a n\hat{ }k-state element. For instance, an 256-state FSR with 100 256-state elements thus may be considered a 2\hat{ }800-state reversible inverter. That is, when a canonical inverse of array A over GF(n) exists as Ai so that A*Ai is a k by k array with A*Ai=I or the identity array. Then Ai may be applied as a reversing n-state inverter.

This allows a rule based inverter that reversibly inverts an input word [x1 x2 . . . xk] into [y1 y2 . . . y3] and reverses it by [x1 x2 . . . xk]=Ai*[y1 y2 . . . yk]. This circumvents the need to store an extremely large vector array as the inverter. One may apply A\hat{ }p as an FSR that is operated p times on the shift register content and Ai\hat{ }p as the corresponding reversing inverter. The by itself allows execution rule based of an FLT on an operation with large integers like 256-bit integers.

One may also FLT the n-state operation on array A by an n-state FLT. That is the base n-state operations of the FSR or the array-vector multiplication may be FLTed by an n-state reversible inverter inv_n, under a condition of inverting all elements of array A (and Ai) with the reversing inverter rinv_n corresponding to inv_n.

While it may be beneficial to store and use complete n by n n-state switching tables or look-up tables, the approach of using the FLT with individual inverters or inverter rules is also very fast and does not require large memory space.

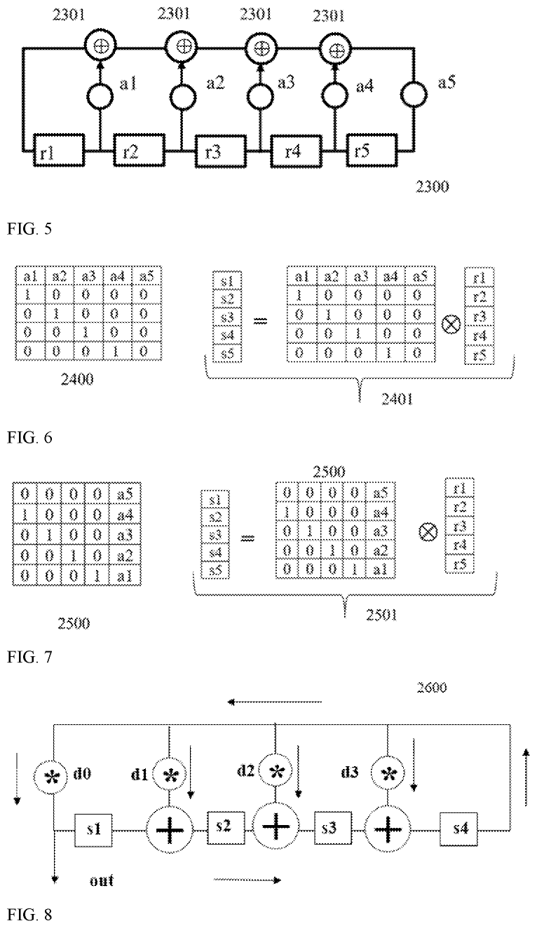

The n-state FSR and transition matrix/array is illustrated in FIGS. 5, 6 and 7. FIG. 5 illustrates an n-state FSR 2300 with a 5-state shift register with content [r1 r2 r3 r4 r5] and taps with factors a1, a2, a3, a4 and a5 and addition-type functions 2301. The terms a1, a2, a3, a4 and a5 are generally considered multiplication factors. In the context of the FLT they may be considered an index of an n-state inverter, or the index of a row in a multiplication table. That means that after an FLT the coefficient may point to a row in an FLTed table and not to a true multiplication factor.

A transition matrix of this FSR is provided in 2400 in FIG. 6. The top row is the set of factors [a1 a2 a3 a4 a5] and the following row indicate the position of a shift register element in the shift register. Diagram 2401 illustrates the computation of the new state [s1 s2 s3 s4 s5] from starting state [r1 r2 r3 r4 r5]. The rules of matrix-vector multiplication apply, using the addition and multiplication over GF(n) rules as the required operations.

One is actually helped by the structure of the reversing Fibonacci FSR. The canonical form of a Fibonacci transition array A (take A is a 4 by 4 array for k=4 FSR) is array A=[a1 a2 a3 a4; 1 0 0 0; 0 1 0 0; 0 0 1 0]. The canonical form of Fibonacci FSR array is: first row of the array is the set of tap coefficients, the next rows indicate the shift of one position of a current shift register element. See FIG. 5 for a 5 element Fibonacci FSR 2300. Doing a textbook inverse of A to A\hat{ }−1 generated for k=4 the array A\hat{ }−1=[0 1 0 0; 0 0 1 0; 0 0 0 1; b1 b2 b3 b4]. This is also (taking in consideration of the size of the array) the canonical form for a k by k inverting array of a Fibonacci transition array. The rule for Ai=A\hat{ }−1 is A*Ai=I with I being identity. This allows a very simple solving of the coefficients [b1 b2 b3 b4] from [a1 a2 a3 a4]. For a Fibonacci FSR with k shift register elements one finds in canonical form: a(k)*b(1)=1 and b(i)=a(i−1)*b(1) for all i not being 1. Thus b(1) in Ai is the multiplicative inverse of a(k) in A. A very simple way to find the multiplicative inverse in mgn or mg256 in GF(256) is the following. Taking into account that Matlab representation is origin-1, the reasoning is that mgn(a,ai)=e with e being the one-element or mg256(a(k),b(1))=2 (in origin-1). Or b(1)=find(mg256(a(k),:)==2). All other terms of fib(i) are computed by b(k)=mg256(a(k−1),b(1)). This is a very fast routine and practically not limited to any size. Herein mg256 is the multiplication over GF(n) or GF(256) in the example and scn is the addition over GF(n) or GF(256) in the example. The above inverse if computed for GF(2\hat{ }t). For non-binary fields one should take care of the minus operation.

The reversing Fibonacci transition array is illustrated for a 5 by 5 case in FIG. 7 with 3900 the reversing transition array and 3901 illustrating a reversing operation on a shift register content. The reversing array also applies to the powers of arrays. Assume A\hat{ }m representing the MF-FSR shifted m times and Ai being the reversing array. Then Ai\hat{ }m reverses A\hat{ }m and A\hat{ }m*Ai\hat{ }m=I.

The above approach in determining a reversing transition matrix/array for the Fibonacci configuration is used instead of computation of the textbook inverse, which becomes computationally time consuming for k>10. The canonical form of determining the reversing matrix this way reduces complexity of computation of about O(n\hat{ }3) to O(n). With the above a very powerful method is provided for easily finding the inverse transition array, even if the transition array has hundreds or even thousands of columns and rows. This would not be easily determined if one needed to create textbook array inverses.

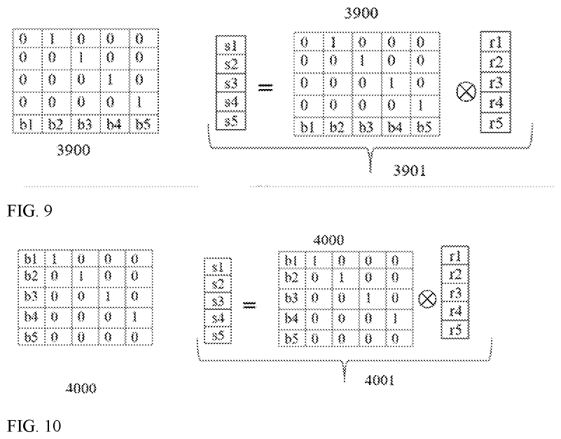

The FSRs as described, so far have been n-state FSRs in Fibonacci configuration. FSRs in Galois configuration are equivalent, but have a different structure in that the “addition” device is located between the shift register elements. A 4-stage n-state FSR in Galois configuration is illustrated in FIG. 8 2600. A Galois transition array for a 5-state FSR is illustrated in FIG. 9 as Galois configuration of a 5-stage, n-state FSR.

While the 5-state Galois and Fibonacci FSRs are equivalent, they do NOT show equivalent behavior of the content of the shift registers. The shift register of the Fibonacci FS flushes out, while, due to inter-element functions, the content of the Galois FSR may change after each shift.

FIG. 9 shows the canonical form of the base transition array for a k-state FSR (illustrative k=5) with 3900 the canonical base array for k=5 and with the last column of the forward canonical base array reflecting the coefficients of the primitive monic polynomial of degree 5 over GF(5). FIG. 9 3901 illustrates the array vector multiplication over GF(n).

One can easily check by writing out the relevant descriptive equations of the Galois FSR that a 5 stage Galois FSR with polynomial coefficients [1 a5 a4 a3 a2 a1] has as transition matrix matg=[0 0 00 a5; 1 0 0 0 a4; 0 1 00 a3; 0 0 1 0 a2; 0 0 0 1 a1] and the corresponding inverse matrix for operating the FSR in reverse direction is matgi=[b1 1 0 0 0; b2 0 1 0 0; b3 0 0 1 0; b4 0 0 0 1; b5 0 0 0 0]. The canonical reversing array is illustrated for k=5 in FIG. 10 4000 for Galois with 4001 illustrating the reversing array vector multiplication. By writing out the equations that describe the shift register content and using matg*matgi=I is the identity matrix one determines that a1*b5=1 (or identity) and thus b5=a1-1. Also one can determine that b1=a2*a1-1; b2=a3*a1-1; b3=a4*a1-1; b4=a5*a1-1. Using this approach in a more generic canonical form will run much faster than using the standard matrix inversion method. One may call this a canonical method for determining a reversing Galois matrix or array. The canonical form of the reversing transition array/matrix of a 5-state Galois configuration is provided in FIG. 10 with 4000 being the canonical form that is easily adapted for any k state Galois configuration and 4001 illustrates the computation of determining a next shift register content applying 4000, using the matrix-vector multiplication rules, in the present cases using multiplication and additions over the related finite field GF(n). Again, these forms are called canonical forms herein that may be extrapolated to other values of k.

The canonical form of the forward Fibonacci transition array is a first row [a1 a2 . . . ak−1 ak] and each following row a row with all 0s with a ‘moving 1] so that the second row is [1 0 . . . 0 0] and the last row is [0 0 . . . 1 0] and the corresponding reversing array is a k by k array with the first row [0 1 . . . 0 0] the next to last row is [0 0 . . . 0 1] and the last row is [b1 b2 . . . bk−1 bk] and elements bi are computed by a(k)*b(1)=1 and b(i)=a(i−1)*b(1).

The Galois transition arrays in forward direction are k by k arrays, with the first k−1 elements of the first to last row ranging from [0 0 . . . 0-], [1 0 . . . 0-] to last row [0 0 . . . 1-] with the ‘-’ element indicating the last column of the array, being [ak ak−1 ak−2 . . . a1] wherein these are the coefficients of the primitive polynomial that determine the n-state Maximum Length Feedback Shift Register(ML-FSR). The reversing Galois transition array in canonical form is a k by k array with the elements from the second to last column ranging from [−1 0 . . . 0], [−0 1 . . . 0] to next to last row [−0 . . . 1] to last row [−0 . . . 0] and the first column being [b1 b2 . . . bk] with elements bi being computed as: a(1)*b(k)=1 or b(last)=a(1)\hat{ }−1 and b(i)=a(i+1)*b(k) for all i not being k.

The term ‘canonical’ refers to the structure of the arrays. This structure applies to any k by k size. In Fibonacci only the first row is variable and depends on the primitive polynomial and in the reversing array only the last row. While in Galois the last column and first column determine the ML-FSR while the rest of the structure of the arrays stays the same. For Fibonacci forward: row 2 being [1 0 . . . 0] and the kth row being [0 0 . . . 1 0]; Fibonacci reverse array: first row being [0 1 . . . 0] and the (k−1)th row being [0 0 . . . 1]; and Galois forward first column being [0 1 . . . 0]’ and the (k−1)th column being [0 0 . . . 1]’; and Galois reversing array second column being [1 0 . . . 0]’ and kth column being [0 0 . . . 1 0]’.

Based on the above, one now has a reversible n-state inverter based on a n-state ML-FSR created from a primitive polynomial over GF(n) of degree k. The n-state ML-FSR is expressed as a k by k n-state transition array (A). The forward n-state transition array A has an inverse k by k n-state transition array determined by a simple canonical rule, wherein A*Ai=I (identity). There are p different instances of the ML-FSR based inverter, related to p possible shifts expressed as A\hat{ }p or in reverse Ai\hat{ }p which is identical to A\hat{ }−p. The number p of different n-state inverters related to a single ML-FSR is n\hat{ }p−1. The all-0 state herein is mapped to all-0.

The n-state inverter may be used in a FLT of a large sequence of bits, for instance for 128 bits. Using n=256, the 128 bits can directly be represented by a word of 16 bytes, as 1 byte is a 256-state element. The sequence of 128 bits is equivalent of a word of 16 bytes. And one should find, for instance with Magma Calculator, a primitive polynomial of degree 16 over GF(256). An example will be provided. While the word of 128 bits is in the illustrative example represented in 256-words, one may also represent it in 16-state words or 32 bit words.

One concern may be the mapping of all-0 to all-0. This may be resolved by FLTing the n-state inverter, which is an n-state FLT. A rule for that is selecting an n-state reversible inverter and its corresponding reversing inverter. All elements of the transition array (be it A, Ai, A\hat{ }p or Ai\hat{ }p) are inverted with the reversing n-state inverter and the addition over GF(n) and the multiplication over GF(n) which are used in the ML-FSR are FLTed with the n-state inverter. This will be demonstrated in the context of the previous example.

Going to Magma Calculator and checking that Magma for GF(256) applies polynomial x\hat{ }8+x\hat{ }4+x\hat{ }3+x\hat{ }2+1 which is used to generate mg256 the multiplication over GF(256). Letting Magma generate h:=RandomlrreduciblePolynomial(F,16) and check IsPrimitve(h) one finds for instance ff16=‘$.1\hat{ }16+F.1\hat{ }98*$.1\hat{ }15+F.1\hat{ }25*$.1\hat{ }14+F.1\hat{ }27*$.1\hat{ }13+F.1\hat{ }60*$.1\hat{ }12+F.1\hat{ }84*$.1\hat{ }11+F.1\hat{ }84*$.1\hat{ }10+F.1\hat{ }107*$.1\hat{ }9+F.1\hat{ }99*$.1\hat{ }8+F.1*$.1\hat{ }7+F.1\hat{ }254*$.1\hat{ }6+F.1\hat{ }129*$.1\hat{ }5+F.1\hat{ }213*$.1\hat{ }4+F.1\hat{ }233*$.1\hat{ }3+F.1\hat{ }191*$.1\hat{ }2+F.1\hat{ }50*$.1+F.1\hat{ }16’

Using an inventor generated extraction program, one finds ff16terms=[2 99 26 28 61 85 85 108 100 2 255 130 214 234 192 51 17] in origin-1.

Computing the numerical representation (as the extracted terms are powers of primitive field element F) one finds terms=[2 135 7 25 112 215 215 209 18 5 2 47 250 252 131 11 153] and placing it in a Galois canonical form one finds the canonical 16 by 16 256-state Galois transition array gal16 with last column [153 11 131 252 250 47 2 5 18 209 215 215 112 25 7 135] and the inverse from the canonical form gal16i with the first column [79 256 156 142 32 12 45 188 164 154 154 239 233 59 212 12]. Doing the matrix multiplication over GF(256) of gal16 with gal16i will generate identity.

The Constructed n-State Inverter from a Smaller (n-State) Sequence

A secret n-state reversible inverter herein may be a source for secret transform of data and/or of an n-state operation, being at least one operand or at least two-operand based. Using a reversible n-state inverter transform may increase significantly the security of cryptographic operations such as those known as cryptographic primitives.

In cryptography one may have several modes of operation. One mode may be a single user or a central user (user being a computer often) in control. For instance, a single user may generate ciphertext that is stored in the Cloud to be later retrieved. By having data encrypted securely, it may be stored securely outside a user's control, because the encrypted data is (presumably) impossible or difficult to decrypt without essential parameters, like an applied n-state reversible inverter. Because there is one user or controlling user, there may not be a need for insecure distribution of the inverter (and/or keyword) because these are securely maintained.

This allows a user or computer via for instance a Key Management System to record, preserve and manage parameters like key and inverters. And a user of computer may use locally stored, never shared, n-state reversible inverters that only the user or computers under control of this user may apply. So, a user may locally generate or obtain one or more secret n-state inverters that only the user knows of and may use. So, the user may easily store a million or 100 million different 256-state or 16-state reversible inverters.

In a second mode, 2 computers that “don't know” each other want to communicate securely. Like a client and a server in a public network, like a bank server and an account holder. Such systems are known under for instance TLS 1.3 protocol and apply one of pre-defined Public Key Infrastructure (“PKI”) methods, such as RSA, ECC, Diffie Hellman, Kyber or other PQC method or any other shared method or public key method to create a shared secret keyword. In accordance with an aspect of the present invention, an n-state reversible inverter which may be represented as a sequence of n different symbols, usually n-state symbols, is derived from a common key such as a shared PKI key. This is unusual because of several reasons: 1) a shared key is relatively small, like 256 bits or equivalent 32 bytes and thus shorter than for instance a 256-state reversible inverter which would be 256 bytes long, 2) even the shared key likely has duplicate bytes, and 3) it is presently unknown or unpublished how to create a reversible n-state inverter from a shorter sequence of elements.

In a first step one expands a sequence equivalent to q bits to one equivalent to p bits with q<p. One may apply one of different well known expansion methods, including cryptographic key expansion, Feedback Shift Register applications, and Key Derivation Functions (KDFs) such as PBKDF2, HKDF, bcrypt, scrypt. Which may be modified to fit a required sequence length or may itself include transformations like FLT to make outputs less predictable. Other methods include hashes and multiple hashes that generate a 256 or 512 bit hash from an input that may be smaller. By repeating the process (hash of the hash) one can create any size of bit sequence and select deterministically a number of bits that one needs. In yet another method one may use the Key Expansion method as prescribed in AES FIPS-197 which creates a 240 byte array out of a 32-byte input. By setting the counter in this procedure one easily expands the output to for instance 256 bytes or more.

There is no guarantee that an expanded sequence includes a reversible n-state inverter. For instance, the inventor expanded in Matlab the Key Expansion routine of AES to 256 bytes, and in all cases at least one duplicate occurred. Accordingly, one needs steps to change deterministically a sequence of n n-state symbols with duplicate n-state symbols to a sequence of n different n-state symbols. One may construct different orders of actions, but in essence the following method works very well.

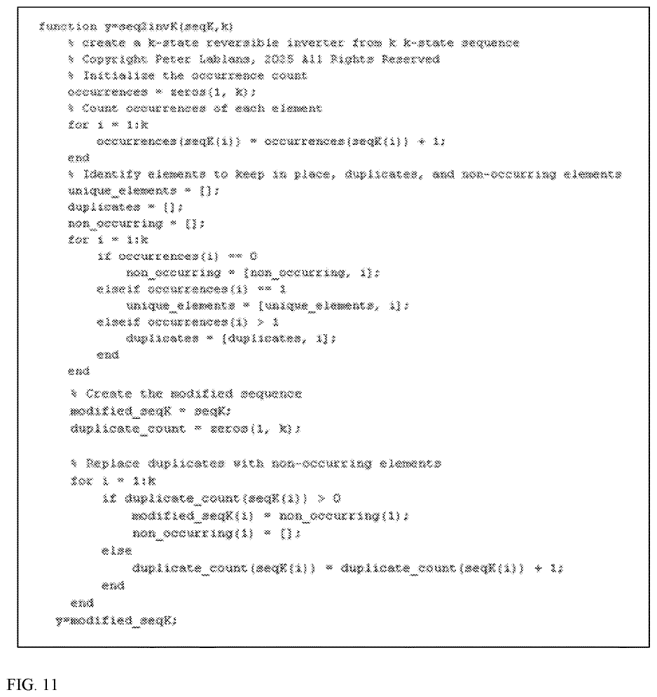

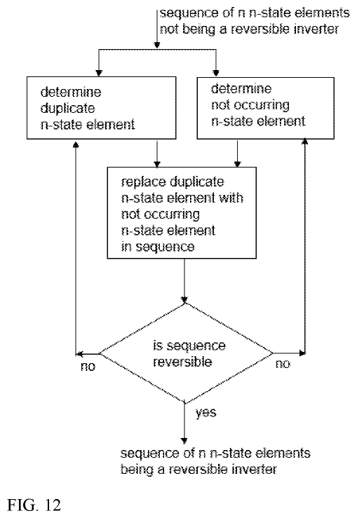

The method is illustrated in FIG. 11 in a Matlab function and in FIG. 12 as a flow diagram. The method uses several steps: it creates two lists: a first list of duplicate n-state elements and their position in the sequence and a second list of missing n-state elements that would make the sequence a reversible n-state inverter. Because an n-state reversible inverter has n different n-state elements. The program may take several approaches to go through the two lists. One approach is that it looks at the first duplicate n-state element and notes its position, it replaces the duplicate with the first element of the missing elements and then updates the lists. It repeats this process until the list of duplicate n-state elements is empty, which also ensures that the list of missing elements is empty. The sequence has now n n-state elements with no duplicates and is an n-state reversible inverter. This is a deterministic process that starting by different parties with the same sequence of n n-state elements creates the same n-state reversible inverter.

One may apply different orders of operations, like: first addressing all duplicates of a particular n-state element. It may occur twice, but also 3 times or even more. One may also go through the list of duplicates, moving from a first element with duplicates, to a second element with duplicates, etc., until the entire list is traversed and the computer checks if the number of unique elements is n. If not, the process starts all over again until the list of n-state numbers is an n-state reversible inverter.

In yet another embodiment, one may also change the order of substitution of missing elements. For instance, one may check the set of n-state elements in Matlab by sorting the sequence, taking out duplicates and finding the missing elements. The sorting may be in either ascending or descending order. The missing n-state elements may be filled in ascending or descending order. One may also split the list of missing elements and interleave the two parts, creating yet another deterministic way to create a reversible n-state inverter.

In accordance with an aspect of the present invention one may create an n-state reversible inverter from a sequence that is smaller, for instance equivalent in bit representation, than an n-state reversible inverter. For instance, a computer receives a sequence of 32 bytes, with at least 1 byte in duplicate. One may also receive a sequence of k bytes that has only unique bytes. In a first step all bytes may be reduced to 32-state elements or 5 bits equivalent. The above procedure is applied to create a 32-state reversible inverter, having for instance all elements ranging from 1 to 32. Assume this sequence is called inv32. One instructs a computer, for example in Matlab that inv64=[inv32 inv32+32], This creates a 64 state reversible inverter. One may also create an interleaved and less predictable 64-state inverter by interleaving the elements of inv32 and inv32+32. To make it even less predictable one may flip one or both sequences before interleaving. For instance inv64(1:2:end)=inv32 and inv64(2:2:end)=inv32+32.

One may repeat these steps with flips or not for inv128 and inv256 to create a significantly random looking inv256. The above example using 32 bytes to generate a 256-state reversible inverter in Matlab is to illustrate the steps of expansion and interleaving.

### Self-Propagation

In accordance with an aspect of the present invention, a confidential n-state inverter, which is preferably reversible, is applied as a seed inverter invseed that generates or propagates different follow-on n-state inverters. One may initialize invn=invseed. And then express in Matlab invn=invn(invseed) or invn=invseed(invn) or even invn=invn(invn). This generates generally a next n-state inverter. Matlab has an elegant expression, but other computer languages have similar short expressions. For instance, Python (Numpy) as well as R, Julia and C++ offer this in easy implementation.

An issue is not the computer language, but the size of n for self propagation. For relatively small n like n=16 the self propagation space or orbit is small almost in the size of n. But when n increases the self-propagation space or orbit increases. For instance, for n=256 this seems to vary between 600,000 and 4 million. Decent, but not enormous. This changes fairly dramatically with increase of n. As an extra step, one may generate a seed inverter that is larger than the required size. For instance, one may generate a 500-state reversible inverter, let it self propagate and reduce each self-propagated 500-state inverter to a 16-state inverter. Surprisingly, one is now able to generate about 600,000 to 1,000,000 different 16-state inverters.

For instance, using a 1000-state reversible inverter as a seed for self-propagation brings the number of possible different 256-state inverters well over 100 million, routinely. In accordance with an aspect of the present invention, one may further modify each generated k-state inverter in one of several ways: 1) shift/rotate all elements of the inverter one position 2) then flip the generated sequence, 3) add one mod-k to each element of a flipped and/or shifted inverter and 4) split the n-state inverter in two or more parts and switch the order of these parts in a new order. That creates by itself 256\hat{ }4 (or about 10\hat{ }9) variations if one applies all steps 255 times. Other variations (including self-transposition and interleaving) are possible and contemplated. What it shows that with very little effort one has access in a deterministic way to billions of variations. This may include duplicates, but these at those number become difficult to identify for an attacker who doesn't know the seed inverter. And because the inverter changes dynamically, there is no static property for a reasoned attack.

Furthermore, one may apply the above and other modifications to the larger state seed inverter, generating thus yet another set of derived smaller size inverters. And for n=1000 reduced to k=256 one easily captures or self propagates well over 1 billion different 256-state reversible inverters. One may do this dynamically. That is, while a processor, which may include a processor core or a processor in a set of 2 or more processors, generating a new k-state inverter while a previous inverter is applied, for instance to an encryption, a decryption or a hash and new inverter is made available for processing a next session, a next message or next file, a next packet, a next block, a next round or even a next byte or word of bits. This creates what the inventor calls real-time cryptographic agility.

In accordance with an aspect of the present invention, an active self-propagation may apply 2 or more generating steps to generate an active n-state inverter. One may also switch seed inverters after for instance ‘w’ generations of n-state reversible inverters.

Repeated trials have demonstrated that the self propagation based on seed inverters that are 2000-state or greater generate reduced 256-state reversible inverters (by stripping excess elements >256) in a range from minimally 10 million to 500 million or greater. Above it was suggested to further modify derived 256-state inverters. Furthermore, one may use deterministic modifications of data that is used to generate a seed inverter. For instance, one may reverse or flip the elements of a shared key used to derive the seed inverter. One may apply the above modifications also upon a minimum of 20 million variations. Accordingly, one can easily achieve internally based on 1 set of data such as a constructed shared Kyber key or other shared secret key of 32 bytes or other size at least 1 billion pseudo-random looking n-state inverters.

One may expand this further. For instance, by applying 2 or more different shared keys. Or another way would be to derive a hash from a shared key. SHA-512 will generate a 512-bit hash or 64 byte hash which may be used to create a new seed inverter.

It is believed that so many examples are provided herein, how an n-state reversible inverter may be generated deterministically, even dynamically, from a base set of symbols that it should be clear that one of ordinary skill, once provided with a base principle now can create many variations thereof, without having to exhaustively provide all possible ways. In fact, it is clear that one may create an n-state reversible inverter from a set of data that is preferably secret, called also cryptographic data, wherein the set of data equivalent in bits is smaller than the size of the n-state reversible inverter in bit equivalence.

As used herein, the term cryptographic data refers to data that is generated by, derived from, or used internally within a cryptographic operation or cryptographic primitive. Cryptographic data is distinct from plaintext or “in the clear” data, which by itself is not cryptographic data.

Cryptographic data includes, without limitation:
ciphertext produced by encrypting plaintext,
hash outputs generated from input data,
encryption keys, decryption keys, shared secret keys, or other key establishment outputs,
digital signatures, message authentication codes (MACs), or similar authentication artifacts,
intermediate values produced during encryption, decryption, hashing, signing, verification, or key exchange operations.

Cryptographic data may be confidential or secret and does not reveal the original plaintext without additional information or processing. Cryptographic data may be produced using symmetric key algorithms, public key algorithms (including Diffie-Hellman, RSA, ECC), lattice based algorithms (including Kyber NIST FIPS 203), hashing algorithms, or any other cryptographic mechanism.

### The p by p Array Method

Certain n-state reversible inverter generating methods herein, require full size availability of inverter data. When n reached a certain size, as is greater than 1000, the requirements for storage size may become too large. In that case, it may be preferable to apply an n-state reversible inverter rule that inverts and reverse inverts individual n-state elements as they are provided. The FSR method as disclosed above is such a rule based inverter that works well for n-state reversible inversions for very large n, for instance n being assize at least equivalent with a word of 100 bits. Elliptic Curve Cryptography (ECC) works with elements of equivalent size of about 256 bit length words in ECDH, and preferably greater.

Traditional Diffie-Hellman recommends at least 2048 bit word size, and preferably at least 4096 bit word size. Similar recommendations exist for RSA key exchange. For this word size, stored inverters are unpractical and a rule based inverter and reversing inverter may be required.

A simple reversible rule based inverter is y=a*x+b mod−n with reversing rule x=(y−b)*a\hat{ }−1 mod−n. In accordance with an aspect of the present invention the following rule based n-state reversible inverter is provided. One establishes a p by p reversible/invertible n\hat{ }1/p state array A over finite field GF(n\hat{ }1/p) with p an integer greater than 1. A simple example is to create a 256-state reversible inverter, by creating a 2 by 2 invertible array A with 16-state elements over GF(16). A probability that a 2 by 2 array of (random) 16-state elements is invertible over GF(16) is about 0.93, which is fairly high. That probability approaches to 1 when n increases. Or specifically when n=2\hat{ }k, then the probability of A being invertible increases as k increases and rapidly approaches 1.

This is significant because when A is invertible then of course Ai=A\hat{ }−1 exists. And Ai may easily be computed using standard methods, applied over GF(n). This means that a rule based reversible inverter also has been created. Take as input an n-state operand (for example n=256) and represent the 256-state element in 2 radix-16 elements [x1 x2]. With A being an invertible 2 by 2 16-state array, then [y1 y2]=A*[x1 x2} over GF(16) in the example. Herein, [y1 y2] is a radix-16 representation of the inverted 256-state element. And Ai*[y1 y2} is the reversing 256-state inversion rule. For example, in origin-1 assume A is 16-state 2 by 2 array in Matlab notation: A=[3 4; 7 9]. Computation over GF(16) provides Ai=[4 7; 13 5] and A*Ai over GF(16) in origin-1 generates [2 1; 2 1] which is identity in origin-1. For instance, 16-state input operand [12 7], with the example inversion rule provides as output [16 11] and reverts back to [12 7] with Ai.

A conversion program generates the radix-16 presentation into a 256-state representation. It is again emphasized that internally to a computer all elements are merely sets of signals or states of physical devices, and any meaning as a number is a human interpretation, facilitated by output representation on for instance a screen or in print.

One aspect of generating n-state inverters that way with invertible p by p arrays, is that input 0 or [0 0] or more zeros, will always generate 0. One may modify that by using steps like shifting, interleaving, adding a factor, etc. In accordance with an aspect of the present invention, one may use a base m-state array, wherein n<m\hat{ }p and k<m. For instance, in order to create a 256-state reversible inverter, one establishes a random looking 2 by 2 invertible array of 17-state elements (A17) over GF(17). So, m=17 and 17\hat{ }2=289. One may generate all [y1 y2]=A17*[x1 x2}. For all possible 17-state x1 and x2 one gets 289 different outputs or a 289-state reversible inverter.

One advantage is that there are more variations for n=289 than for n=256. For instance, there are 16\hat{ }4 different 2 by 2 16-state arrays and 17\hat{ }4 17-state 2 by 2 arrays. The difference is significant. One may reduce a thus generated 289-state reversible inverter to a reversible 256-state inverter, as follows. 1) set a criterion that selects 256 of the 289 generated elements. For instance, the Matlab statements:
if dd>1 && dd<258
   tel=tel+1;
   inv289(tel)=dd;
   end
selects 256 different elements from 289 different elements. The selected elements are in the range 2 to 257. So, while having 256 unique elements, it is not a reversible inverter as there is not a complete bijection between positions in the sequence 1 to 256 in Matlab origin-1, and the states 2 to 257. 2) This is resolved by replacing element 257 with element 1. And a reversible 256-state inverter has been created.

As an illustrative example, a replacement of 1 outlying element with 1 missing element has been provided. One of ordinary skill will recognize that other replacement schemes may be applied and are contemplated. For instance, one may set as condition: if dd>5 && dd<262. This determines from 289 unique elements, 256 unique elements in range 6-261. By a substitution of 257-261 by 1-5, one creates a 256-state reversible inverter.

One may call this q to n reduction, such as 289 to 256 reduction. An advantage of this is that all q-states are dealt with individually and one is not limited by the size of q besides a processing time to go through all q states. For instance, one can do a q=2\hat{ }16 to n=2\hat{ }8 reduction. Unfortunately, the reduction of the reversing inverter of the q-state reversible inverter is not identical to the reversing inverter of the reduced n-state inverter. One has to compute the reversing n-state inverter from the reversible n-state inverter itself. Practically, this may mean that one requires to have the entire n-state reversible inverter, when one uses aspects of the herein provided reduction approach. So, one may apply this easily for n=256 up to n=2\hat{ }16 or greater. However, for larger n this may become unpractical.

For large n, like n=2\hat{ }32, one may apply a standard 2 by 2 array over GF(2\hat{ }16). Or, if one wants to use better known functions over GF(256), one may use a 4 by 4 array A of elements over GF(256) and represent a n=2=state element in [x1 x2 x3 x4] radix-256 representation. A simple way to resolve the zero to zero mapping is to apply a preset shuffle or interleaving or shifting.

A property of reversing n-state reversible inverters as discovered by the inventor, is the following. One may use a known n-state inverter with a known reversing inverter as a given, either as a rule or as a stored array. One then applies a transformation to the inverter or inverter rule. In general, one may apply a rule related to that transformation rule to the known reversing inverter to compute the correct reversing element caused by the transformation of the reversible n-state inverter. As a consequence, one doesn't have to recompute the entire new reversing inverter. It suffices to compute the individual reversing results. This is beneficial for relatively large n, like n is 32 bits wide for instance.

As an example, use a 16-state reversible inverter inv16 that has 1 as its zero element in Matlab (origin-1) and its reversing inverter is rinv16.
inv16=[1 3 4 6 10 16 12 5 14 11 2 9 15 8 7 13];
rinv16=[1 11 2 3 8 4 15 14 12 5 10 7 16 9 13 6];

The following transformation rule is applied: split the inverter in two equal parts, flip the elements in the first part ([a1 a2 . . . a8] becomes [a8 a7 . . . a1) and recombine the two parts, now [a8 a7 . . . a1 a9 10 . . . a16]. This creates:
inv16n=[5 12 16 10 6 4 3 1 14 11 2 9 15 8 7 13]. One can see that the zero-element is no longer 1.

The rule for the new reversing inverter rinv16n(i) is: 1) determine rr=rinv16(i); 2) if rr<n/2+1 or rr<9 then rinv16n(i)=9-rinv16(i), or more general rinvnn(i)=n/2+1−rinvn(i); if rr>n/2 then rinvnn(i)=rinvn(i). Computing for each i provides: rinv16n=[8 11 7 6 1 5 15 14 12 4 10 2 16 9 13 3].

For illustrative convenience, the inverter was split in 2 equal parts. This is not required as one may split it into any k and (n−k) parts. One has to adjust the rule for: 2) if rr<k+1 then rinvnn(i)=k+1−rinvn(i); if rr>k then rinvnn(i)=rinvn(i).

For example one may use 16-state array A16=[2 12; 14 4] over GF(16) as a 256-state rule for element wise generation of a 256-state reversible inverter. A corresponding reversing inverter rule is A16i=[15 10; 7 12] over GF(16). One can check that A16*A16i over GF(16) provides I=[1 2; 2 1] in Matlab origin-1.

One potential issue, with using flipping a block of k n-state elements is that in the new reversing inverter the zero-element is always k. One may address that, by an additional transformation. For instance, one may shift all elements in the inverter in a circular fashion by m positions left or right. In Matlab one may use the statement invnew=circshift(invn, m). The change in the reversing inverter is deterministic. Assume that the reversing inverter of invn is rinvn, either through a rule or stored sequence. The reversing inverter rinvnew of invnew is determined by Matlab statement rinvnew(i)=mod(rinvn(i)−1+m, n)+1. One may execute all statements element wise as being rule based. For instance, one may flip first a block of 37 elements, which creates a reversing inverter with zero element 37. By then applying a circular shift of 9 positions to the new inverter one creates yet a new reversible 256 state inverter with a computed reversing inverter with zero-element 46. Using a circular shift m=−9 or 9 positions left, one creates a reversing inverter with zero-element 28.

The above teaches at least several ways how to generate and/or modify element wise a reversible n-state inverter and its corresponding reversing inverter, by applying rule based or index based transformations. There is no need to compute entire inverters or reversing inverters, but only individual elements. Simple transformations have been provided for illustrative purposes. Other and/or more complex transforms are possible and contemplated. For instance, one may flip a block that does not include a last or first element of the inverter. One may interleave sections of an inverter, and/or transform by y=a*x+b mod-n.

In accordance with an aspect of the present invention, one may use secret key data as one or more parameters for inverter generation. This may include an inverter generating array, block size for flipping, number of shift positions and others.

### Composite Inverters

In accordance with an aspect of the present invention an n-state reversible inverter is created as a composition of two or more reversible inverters. For instance, in Matlab description: inv_n=[inv_p inv_k] or a concatenation of 2 independent inverters, a p-state reversible inverter and a k-state reversible inverter. One may generalize that to: inv_p having p elements 1 to p and inv_k having n-p elements in range k+1 to n. Thus, inv_n has elements 1 to n and is a reversible n-state inverter. If so desired, one may create a composite inverter with more than 2 parts.

A benefit of creating such a composite inverter is that it may consist of a small fixed, possibly stored, inverter and a rule based inverter, which may establish a larger part of the inverter. A small part inverter may even be identity. Or identity flipped. This allows a non-rule based inverter such as for n being prime, being constructed from a large n1-state rule as explained above and a small n2-state inverter. For n, for instance. being a 256 bit prime, one may use a 255-bit inverter using a rule complimented to the prime n. It may be surprising to learn that a density of primes for numbers of 256 bits is fairly high, as related to a distance between 2 consecutive primes. For instance, the difference between x=2\hat{ }255 and the next prime greater than x is 95. This may easily be determined by powerful on-line computational applications like Magma Calculator, available on https://magma.maths.usyd.edu.au/calc/. The following set of instructions in Magma generates as result 95. x:=2\hat{ }255; y:=NextPrime(x); print(y−x);

The probability that a random number is in the set between 2\hat{ }255 and the next prime is vanishingly small. One may define an inverter for n=2\hat{ }255 by a rule and compliment the inverter by inv95+2\hat{ }255, wherein inv95 is a sequence of 95 unique elements in range 1 to 95. A rule for n=2\hat{ }256+p for example. In that case one may use q=2\hat{ }128 and use an 2\hat{ }128 state array arr128=[a b; c d] and make sure it is invertible and use it as a 2\hat{ }256 state inverter. As discussed earlier, a 2 by 2 n-state array certainly for large n is almost certainly invertible.

As an illustrative toy example. One may create a 13-state reversible inverter using an 8-state reversible inverter and a 5-state reversible inverter. Assume: inv8=[7 8 5 6 2 1 3 4] and inv5=[1 2 3 4 5]. Make inv5=inv5+8 or inv5=[9 10 11 12 13] and the composite inverter is inv13=[7 8 5 6 2 1 3 4 9 10 11 12 13]. One may split the inverter in two parts flip them and interleave like: inv13a=[7 8 5 6 2 1 3]; invi3aflip=[3 1 2 6 5 8 7], and inv13b=[4 9 10 11 12 13], and inv13bflip=[13 12 11 10 9 4] and interleaving into invi3new=[3 13 1 12 2 11 6 10 5 9 8 4 7]. All steps are invertible rules all being captured by specifics rules. One may make one or more additional reversible modifications. Like adding a number ‘Inc’ to all elements of the inverter. Shifting left or right of elements one or more positions, either in the partial or total inverter. Etc., etc.

To demonstrate one may apply the above steps in a rule-based way, one may assume inv8 and inv5. The inverter inv8 may be formed based on a rule. Inverter inv8 has k1 elements and inv5 has k2 elements. Let inv51=inv5+8. One then forms inv13_1, wherein: inv13_1=[inv8 inv51] with n elements. For i=1:k1 with k1=8 in inv13_1 one applies to inv8(i). For i=k1+1:k2 with k2=13 one applies to inv51(i−k1). In that case: one checks what the value of i is and then determines inv13_1(i) by applying it to the partial inverters.

The splitting in 2 parts provides j1=i for inv13a(j1) for i=1:7 and inv13b(j2) for j2=i−7 for i=8:13.

The flipping creates a new index h1 and h2. Inverter inv13a_flip(h1) has h1=7+1−j1 and inv13b_flip(h2) has h2=6+1−j2. Interleaving create index m with inv13new(m) with for m is odd and m=1+h1*2 and for m is even m=h2*2.

For illustrative purposes, the above “wholly stored” inverter generator is modified to be a rule based 13-state inverter that generates based on a single operand an inverted output.

It was explained above that the density of prime number is quite high with a prime number distance of about 100-200 within 256 bit numbers. On that basis one can easily create an n-state inverter formed by a 2\hat{ }255 number and a small extra number to form a prime number.

As an illustrative example one may generate a random 2 by 2 array A=[a11 a12; a21 a22] of 128 bit numbers and first check if A is invertible. As example use A=[15028999336134572794 2342493304808210439; 11664969174483495025 5137385370652011871]. The test if A is invertible is that det(A)≠0 or a11*a22−a12*a21 mod 2\hat{ }256≠0. In Matlab for large integers one should use VPI toolbox. One gets a11*a22=77209761324996552599506484495201637574; and a12*a21=27325112192021744612010585712409565975. And these two products are not equal, so the array A is invertible. One is reminded that for this purpose the numbers are mod-2\hat{ }256. Using z=vpi(2)\hat{ }256 in Matlab, one gets z=115792089237316195423570985008687907853269984665640564039457584007913129 639936. And z>>than a1 1*a22 or a12*a21.

One may use num=A*[x1 x2] mod 2\hat{ }256 in decimal form as a rule-based 2\hat{ }256 state inverter. The reversing inverter is A\hat{ }-1=1/det(A)*[a22−a12; −a21 a11] mod 2\hat{ }256. Using the Extended Euclidean Algorithm mod 2\hat{ }256 one finds invd=553531866014847558512406679382118285490477340697250503909809731799914159 95727. One may now apply an FLT to for instance a multiplication mod-2\hat{ }256.

The above provides an n=2\hat{ }256 state reversible inverter as well as its reversing inverter as a rule. One disadvantage may be that 0 is transformed onto 0. One can address that by a simple shift of the elements in the sequence by s positions. This inv_new(i)=inv_old(i−s) for instance or inv_new(i)=inv_old(i+s) where the shift is mod 2\hat{ }256, in a front-to-tail or tail-to-front shifting.

One may create an n-state reversible inverter from this with n=2\hat{ }256+q and n being prime using Magma's x:=2\hat{ }256; y:=NextPrime(x); print(y−x); This establishes q=297, for which one may use identity q=1:297 and apply the steps as explained above. Or if one wants to stay within 256 bits: x:=2\hat{ }255; y:=NextPrime(x); print(y−x); with q=95. Other modifications are possible and fully contemplated.

One may seed the arrays required for the n=q\hat{ }p state reversible inverters with elements of a set of bytes. For instance, the above set of 128 bits may be taken from a SHA-512 hash of a message, which may be secret. Or by using any known sequence extension method based on a smaller secret set of data.

It is again submitted that once a seed n-state reversible inverter has been established one may use it as a seed for a self-propagating inverter. For the enormous size of n=2\hat{ }128 or greater, one can create a large source of self-propagated inverters that relies on an initial seed. One may load a seed on computing devices that exchange data. Because of the large reservoir of self-propagated inverters there may be no need over a long period of time to refresh the seed. However, one may also artificially refresh by updating an n-state inverter by a shift, a mod-n addition or an interleaving or the like. One may call this self-refresh. For security a complete autonomous refresh with novel seeds may be preferred. However, when physical update is not viable or possible, the use of self-propagation and/or self-refresh may be a viable alternative.

Accordingly, a whole arsenal of different ways, methods and devices to create a shared reversible n-state inverter that provides increased security has been provided herein.

Commutative 2-operand n-state with n>2 involutions that are not additions over Fn or GF(n).

Herein GF(n) and Fn both mean the same thing: a finite field of order n or with n elements. In a finite field n is either prime or a power of a prime number. Finite field theory is used herein to describe switching devices. That is, in the context of the Blaauw framework, one may conveniently use it to describe or model switching or computer devices. However ultimately a working computer requires a physical realization, usually electronic devices. These devices operate by dynamically switching between physical states, as explained earlier, and do not perform finite field math. One may compare it with for instance a description of an electronic device by a complex transfer function over a frequency range or by a differential equation. One of ordinary skill is aware that the circuit itself does not perform the transfer function or differential equation.

The inventor has analyzed and described commutative n-state functions for n=2\hat{ }k and disclosed this in U.S. Provisional Application 63/773,331 to Lablans filed on Apr. 2 2024 which is incorporated by reference and referred to for additional explanation if required. The results of the analysis will be applied here. One aspect found is that all additions over GF(n=2\hat{ }k) described in a lookup table are commutative, thus rows and columns with the same index are identical, while all rows are different and may be described as self-reversing n-state inverters. One recalls that an n-state inverter is described as a sequence of n n-state elements, each element being assigned a state or value and a position in the sequence. When all n elements in an n-state sequence are different, the sequence is reversible. That is when one has a sequence invn=[a1 a2 . . . an] and all elements are different then an n-state sequence rinvn=[b1 b2 . . . bn] exists for which invn(rinvn(x))=x. The inverter invn is reversible. When invn=rinvn then the sequence is called self-reversing.

Furthermore, all rows arranged in a commutative involution matrix or array only have columns wherein each n-state element occurs exactly once. Thus, an n-state 2 operand commutative involution with n=2\hat{ }k has n different self-reversing n-state inverters as rows and columns. For instance, for n=2\hat{ }2=4 there are 10 different 4-state self-reversing inverters. For n=8 there are 764 self-reversing 8-state inverters out of 40,320 reversible 8-state inverters. In general, for n=2\hat{ }k there are more than n self-reversing n-state inverters. The inventor developed several ways to construct novel n-state commutative involutions from this that may be applied in cryptographic machines.

One way is to use the FLT, of course. But another way is to re-arrange the existing n-state lookup table which already has n self-reversing n-state inverters with the required properties related to columns. A lookup table of a self-reversing n-state commutative involution is created by selecting one of the n self-reversing n-state inverters in the table as row 1, instead of identity which is in base form the first row. The each next row is selected by going through the elements of the first row, For instance in 4-state involution addition over GF(4) sc4=[0 1 2 3; 1 0 3 2; 2 3 0 1 1; 3 2 1 0]. Select row 2 for instance as first row in the new involution as sn4=[1 0 3 2; . . . ]. Because each element only occurs once in a column and commutativity, the next row, row 2, starts with element 2 in row 1 which is now 0 and corresponds with [0 1 2 3] element 3 is 3 and corresponds with row [3 2 1 0] and element 4 in row 1 is 2 which corresponds with row [2 3 0 1] and sn4 is: [1 0 3 2; 0 1 2 3; 3 2 1 0; 2 3 0 1]. This is a commutative 2-operand n-state involution, but is NOT a standard addition over GF(4). Thus, one can rapidly find different commutative 2 operand n-state involutions that may also be found by an FLT.

Another and novel way to find novel 2-operand commutative involutions is a sieve program that selects inverters from the set of self-reversing n-state inverters. This set is greater than n. However, not all combinations of self-reversing inverters work out, as columns and rows are not allowed to have an n-state element more than once. So, a loop in a program was created that skips over such a non-valid row/column combination and selects the next one in the set. As was shown in the related provisional Patent Application, a program was able to generate 184 different commutative self-reversing 8-state 2 operand involutions. None of these involutions complied with all the axioms of a finite field F8. Thus, these novel involutions cannot be characterized as an addition over Fn, even while n=2\hat{ }k.

One may create, using a set of 10 self-reversing 4-state inverters a set of 4-state commutative involutions, of which one is sp4=[3 2 1 0; 2 3 0 1; 1 0 2 3; 0 1 3 2]. This 4-state function is commutative and self-reversing and is NOT a function that defines a finite field GF(4). The rows are all 4-state self-reversing inverters. And one may create 3 alternate 4-state self-reversing functions using the selection method as explained above. Such as for instance st4=[0 1 3 2; 1 0 2 3; 3 2 1 0; 2 3 0 1]. One can easily see, that this cannot be a function (using the term in general finite field theory) that is a “law of composition” that defines a finite field. While commonly, ‘+’ and ‘*’ or addition and multiplication are terms used, formally these should be named ‘laws of composition” that meet certain criteria to determine a finite field. The first law of composition (the + or addition) has a zero-element z, so that scn(a,z)=z for all ‘a’ (and z) in GF(n). This means that the function represented in an array-like lookup table, should have identity as a row (and a column). Clearly, sp4 and st4 don't have that. So both are n-state commutative involutions that are NOT a law of composition for a finite field and are NOT an addition over GF(4).

The benefit of the above method is that when has identified one n-state commutative involution that does not represent a law of composition, one may create (n−1) additional n-state commutative involutions that are also not laws of composition for GF(n) by selecting the rows of the related function. However, using an FLT would work as well and with a greater number of variations.

The related provisional patent application illustrates several 8-state commutative self-reversing involutions that are not a law of composition for GF(8) or F8. For instance, [8 7 6 5 3 3 2 1; 7 8 5 63 4 1 2; 6 5 842 1 7 3; 5 64 3 1 2 8 7; 4 3 2 1 8 76 5; 3 4 1 27 8 5 6; 2 1 7 8 6 5 3 4; 1 2 3 7 5 6 4 8] is such an 8-state involution function. As n gets bigger, it will be more time consuming for a processor to generate the n-state commutative self-reversing functions using the sieving method applying all self-reversing n-state inverters. The inventor has developed two methods that allow creating an n2-state self-reversing commutative function from an n1-state self-reversing commutative function, with n2>n1 and n2=k*n1 and k being an integer>1.

The first method is using the n1-state function as a base-function, create n2-state words of k n1-state elements, and create the n2-state function by executing element-wise combination of words of n1-state elements, using all possible n1 state words, and convert the outcome, which will be a set of n1-state words to their n2-state representation.

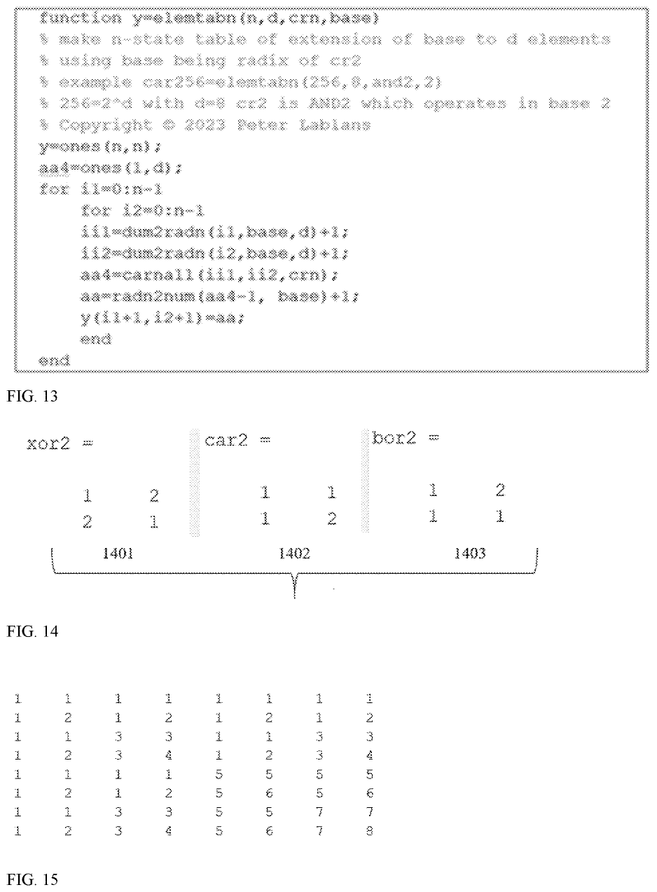

A Matlab function that does such an extended transformation is st16=elemtabn(16, 2, st4, 4) or stn2=elemtabn(n2, k, stn1, n1) as shown in FIG. 13 as a screenshot of this program. This Matlab program creates a word of k n1-elements, executes the n1-element wise operation of words of k n1-elements using the function stn1 and converts the output to an n2 by n2 table. Accordingly, n2=n1\hat{ }k. So, from an 8-state base involution, one may create a 64-state and/or a 512-state involution, but not a 256-state involution as 256 is not an integer power of 8. Using this method. one should use n1=4 and create n2=256 as a word of 4 n1-state elements. In that case one may use the generated 256-state commutative involution, by mixing/transposing the position of 256-state self-reversing inverters to create 255 additional 256-state self-reversing commutative involutions that are not a law of composition of a finite field.

Yet another method of creating an n2-state involution from an n1-state involution is called herein a doubling method. That is, one creates an n2=2*n1 state involution from an n1-state involution. The creation is based on properties of n-state self-reversing inverters. First: a self reversing n-state inverter [a1 a2 a3 . . . an] may be expanded to a 2*n-state self-reversing inverter [a1 a2 a3 . . . an a1+n a2+n . . . an+n]. Second, if [a1 a2 a3 . . . an a1+n a2+n . . . an+n] is a self-reversing inverter then [a1+n a2+n . . . an+n a1 a2 a3 . . . an] is a self-reversing inverter. In this way by “doubling’ one may create a 2*n-state self-reversing function. So, from earlier function st4, by this ‘doubling’, one may create st8=[0 1 3 2 4 5 7 6; 1 0 2 3 5 4 6 7; 3 2 1 0 7 6 5 4; 2 3 0 1 6 7 4 5; 4 5 7 6 0 1 3 2; 5 4 6 7 1 0 2 3; 7 6 5 4 3 2 1 0; 6 7 4 5 2 3 0 1], which is an 8-state, commutative, self-reversing function, which is not a law of composition for GF(8). In this way by repeated doubling, one may create a 256-state self-reversing commutative involution, which is actually different from the earlier generated 256-state involution by element-wise processing. The by doubling generated 256-state involution may be applied to generate an additional (n−1) or 255 involutions which again are not a law of composition for a finite field. Create by doubling 6 time for instance sd256 from above st4. One may then create further modifications by applying an FLT.

The use of the modified n-state involution, which is not a law of composition for Fn, also may solve an issue of the ML-FSR based inversion and the FLT of sequences of bits using the same function. So preferably one uses a reversible inverter for a sequence of bits based on an ML-FSR that is based on a common finite field or an FLT of operations over such a finite field. One then FLTs the sequences of bits but applies a function that is different from what was used to create the ML-FSR based inverter. This may be an n-state commutative involution as described above.

As an illustrative example use the 256-state 4-stage based ML-FSR inverter of 32-bit words as disclosed above. Use as input a 256-state represented cleartext seq32n=[152 84 107 131] and as key key32n=[2 3 4 5] in origin-1. Using the above function sd256 which is an involution but not a law of composition in GF(256). Using this function directly on seq32n and key32n will generate [152 81 105 136]. The FLT, using earlier ‘gal4’ and reversing ‘gal4i’ will generate inverted seq32i=[153 141 88 190] and key32n1=[212 105 193 233]. Performing sd256 on these will generate [75 229 151 86]and inverting with ‘gal4i’ as per FLT rules will create [100 125 252 122]. This while applying sd256 directly to seq32n and key32n (without FLT) will generate [152 81 105 136]. Thus. the FLT completely changes the result. Applying the output against key in the FLTed sd256 operation using the Galois ML-FSR based 256 state inverter will recover seq32n, as expected.

By using a n-state base operation in the FLT of an operation that is different from functions used in generating the ML-FSR based inverter one may circumvent identified issues that may affect security. The bitwise XOR of words of k bits is so ubiquitous that almost no further attention is spent on it in known literature. It is used in encryption, like AES and its modes like AES-GCM and ChaCha20 and its modes for combining keystream with plaintext. In AES it is applied in AddRoundKey( ) as well in generating the RoundKey in Key Expansion. In AES the bitwise XOR is applied to words of 8 bits, arranged in columns or rows as the state array. The use of bitwise XOR is a convenient way to mix two words in an involution. A bitwise XOR of words of k bits may be represented as an addition over GF(2\hat{ }k) and numerically replaced by it when one treats k bits as an n=2\hat{ }k state element. In that case one may FLT the addition over GF(2\hat{ }k) and translate the outcome back to a word of k bits, which will be different from the non-FLTed outcome. The FLT is meta-property preserving and when an operation is an addition over GF(n), its FLT is also an addition over GF(n). Be it that zero-elements and one-elements may have changed. Another property of an addition over GF(n=2\hat{ }k) or addition over GF(n) in general, has an outcome or sum-space that is uniform. That is, using all possible input combinations (a,b) with a and b n-state elements, the outcome of the sum by addition over GF(n) scn is c=scn(a,b) is uniform, or all possible values of c (ranging from 0 to n−1 in origin 0) occur uniformly or exactly n times. So, n time 0, n times 1 to n times (n−1). This means that there is no bias or preference to a certain outcome.

In certain operations (like matrix-matrix or matrix-vector operations) it is important that the operations like + and * are defined over a finite field. However, many of the additions over GF(n=2\hat{ }k) for instance, are used based on its involution property, not on its being an addition over GF(n). For those cases, the bitwise XORing of words of k bits may be replaced by the novel n=2\hat{ }k state commutative involutions as described above that are expressly NOT additions over GF(2\hat{ }k), or an FLT thereof. Especially because these involution functions also have a uniform result or sum-space.

Specifically, this replacement may be applied to AES and AES-GCM, to the AddRoundKey( ) and KeyExpansion( ) as defined in section 5.2 of FIPS 197 specifying AES. Similarly, ChaCha20 applies a bitwise XOR to words of 32 bits defined in for instance RFC 8439. Herein the word of 32-bit may be split into 4 words of 8 bits, for instance, and the words of 8 bits may be processed by the 256-state commutative involution in FLT or non-FLT form and not being an addition over GF(256). The result may be transformed back into a word of 32 bit. The result is numerically different from using an addition over GF(n), but the statistical distribution is unchanged.

As observed before, the use of addition over GF(n) in AES-GCM as well as in ChaCha20 may be in generating a key stream, which is used both in encryption and decryption in the same way. Furthermore, AES-GCM and ChaCha20 use bitwise XOR to encrypt a generated keystream with cleartext. Here the bitwise XOR of words of k bits may also be replaced by the n=2\hat{ }k state commutative involution not being characterizable as an addition over GF(n) on words of k bits, either in FLT or non-FLT form. It is noted that subtraction c=a−b mod−n is also an n-state involution, as b=a−c mod−n. However, this function is not commutative. In accordance with an aspect of the present invention, it may also be used to replace additions over GF(n), in either FLT or non-FLT form. However, care must be taken of correctly recovering encrypted cleartext, as the order of operation is critical.

Bitwise operations on words of k bits are also applied in other cryptographic operations beside encryption and decryption. For instance, they are applied in hashing or message digest operations, for instance as defined in FIPS PUB 180-4 Secure Hash Standard (SHS) available from https://nvlpubs.nist.gov/nistpubs/FIPS/NIST.FIPS.180-4.pdf which is incorporated herein by reference. SHS defines words of w bits, for instance w=32. For instance the bitwise XOR is applied in functions Maj(x, y, z) (4.3) and Ch(x, y, z) (4.2) as defined in 4.1.2 of FIPS 180-4 on words of 32-bits. For instance 4.3 may be reformulated as out11=AND256(x1,y1); out12=AND256(x1,z1); and out31=AND256(y1,z1) and aout1=sc256(out11,out12) and out1=sc256(aout1,out13). Herein x1, y1 and z1 are 8 bits of 32 bits. The function sc256 is the addition over GF(2\hat{ }8) and AND256 is the 256-state representation of the bitwise AND of words of 8 bits.

One may repeat the above substitution for each of the 8-bit words in w=32. When concatenating the results, one gets the desired result of 4.3. In a similar way one may modify operation 4.2 Ch(x, y, z). One may replace the function sc256 (addition over GF(256)) with the 256-state commutative involution NOT being an addition over GF(256). For Ch(x, y, z) that may be a straightforward replacement as this operation has two components combined by sc256. However, for Maj(x, y, z) there are 3 components for determining each set of 8 bits. The 256-state commutative involution not being an addition over GF(2\hat{ }k) is not associative. Thus the result of aout1=sd256(out11,out12) and out1=sd256(aout1,out13) and for instance aout1=sd256(out11,out13) and out1=sd256(aout1,out12) may be different. The result is still repeatable, if the same order of execution is observed using non-associative operations on 3 or more operands, such as in (4.4) etc. of FIPS 180-4. Because sd256 is commutative, replacement of sc256 with sd256 in for instance Ch(x, y, z) requires no additional measures.

Furthermore, FIPS 180-4 defines sets of 32-bit and 64-bit word constants, which may be inverted with ML-FSR based inverters. And, of course, any used n-state commutative involution (being an addition over GF(n) or not) may be FLTed. For instance, by any of the above disclosed generated n-state inverters. For instance, in hashing applications one can use an n-state reversible inverter to invert the input 32-bit or 64-bit words. The output of an FLT modified Ch(x, y, z) or Maj(x, y, z) using the n-state inverter will generate a modified output. That may be sufficient to modify the hashing operation. However, one may replace the addition over GF(n) (bitwise XOR) with an n-state commutative involution that is not such an addition. One should make sure that this involution (if used without other changes) is sufficiently different from the addition over GF(n). This can be achieved by applying a separate (in this case 256-state) FLT to the involution preferably changing the zero-element and one-element. This all makes successful brute force attacks extremely unlikely. It leaves the basic dataflow of hashing intact and provides a customized and secure and private hashing method. The same applies for applying n-state commutative involutions to encryption/decryption, where an additional FLT of the involution will significantly increase security. For instance sc256 (addition over GF(256) and 256-state involution sd256 NOT being such an addition, created by doubling may have a difference of 56%, while an FLT of sd256 may have a difference of 85% with sc256.

In accordance with an aspect of the present invention a set of parameters may contain a parameter that indicates a use of an n-state commutative involution that is NOT an addition over GF(n) and/or is not derived from a bitwise XORing of 2 words of k bits.

In accordance with an aspect of the present invention, an n-state with n=2\hat{ }k 2-operand commutative involution that is not characterizable as an addition over finite field Fn, is applied in a computer implemented cryptographic operation that processes words of k bits. In one embodiment of the present invention, it replaces a XORing of 2 words of k bits. In accordance with an aspect of the present invention, the computer implemented cryptographic operation is one of an encryption, a decryption, a hashing, a public key exchange, a digital signature generation and a digital signature verification.

### Radix-n Operations

A radix-n operation is commonly an n-state operation of words of n-state elements, including 2 operations on individual elements of the words involving elements in corresponding positions and including at least two computational operations. A first computational operation may be called an n-state residue operation. This may be an addition modulo-n, for instance. For example, 5-state processing of 4 and 4, may generate 3-mod 5 as residue of addition mod-5, or 1 as residue of multiplication mod-5. A second operation is a generation of a transition element. In mod-n addition a transition element is called a carry, and a borrow in n-state subtraction. One may use the term transition and/or carry also related to multiplication-like operations, even though the operational states are different from addition-like operations.

A standard or canonical transition array for a modulo-n addition is of the form carn(i1,i2)=(i1+i2>n−1). Or, in origin 0, when a sum of 2 input operands is smaller than n the transition element is 0 and when the sum is greater than n−1 the transition element is 1. For n=4 the transition array is the carry for a modulo-4 addition, or car4=[0 0 0 0; 0 0 0 1; 0 0 1 1; 0 1 1 1]. The borrow corresponding to the mod-4 subtraction is the flipped versions of car4 or bor4=[0 1 1 1; 0 0 1 1; 0 0 0 1; 0 0 0 0]. This shape or from applies actually to all carry and borrow digits modulo −n and is like car_n=[0 0 0 . . . 0 0 0; 0 0 0 . . . 0 0 1; 00 0 . . . 0 1 1; . . . ; 0 1 1 . . . 1 1 1] and a corresponding borrow is a flipped version of carn as in born=[0 1 1 . . . 1 1 1; . . . ; 0 0 0 . . . 0 1 1; 0 0 0 . . . 0 0 1; 0 0 0 . . . 00 0]. In accordance with an aspect of the present invention, one may actually modify the canonical n-state carry function/table by changing 0 to another n-state symbol and 1 yet to another one.

One may modify the transition table with an FLT. For instance using a 5-state canonical carry table car5=[0 0 0 0 0; 0 0 0 0 1; 0 0 0 1 1; 0 0 1 1 1; 0 1 1 1 1] and apply the FLT using inv5=[3 4 0 1 2] one gets as modified car5f=[3 3 2 2 3; 3 3 2 3 3; 2 2 2 2 2; 2 3 2 2 2; 3 3 2 2 2]. This does no longer look like the canonical form of the carry or transition function/table. However, the distribution of modified zero elements (now 2) and one elements (now 3) remains the same. In accordance with an aspect of the present invention, one may change a canonical n-state transition function/table (be it the carry or the borrow) into a non-canonical one, by applying an n-state FLT using an n-state inverter that is not identity.

There is a second set of canonical n-state carry and borrow functions that create a reversible radix-n addition for n=2\hat{ }k. This corresponds to a different reversible operation. The earlier canonical n-state function/table corresponds to a modulo-n addition. The one provided next corresponds to an extension or power of a base operation. One of the most widely operations in cryptography is the XOR operation, which may be represented by the modulo-2 operation. The switching table XOR2 in Matlab origin-1 is illustrated as a screenshot in 1401 of FIG. 14, with a corresponding carry function/table car2 1402 which is as device an AND gate and 1403 a corresponding borrow table bor2, keeping in mind that addition mod-2 and subtraction mod-2 are identical functions and are called an involution. The following may be applied to any extension for n=p\hat{ }k with p a prime number. However, p=2 is by far the most widely used computer function for this purpose. One should also keep in mind that for arithmetical purposes one generally does not apply subtraction but rather the 2s complement addition.

The addition GF(n=2\hat{ }k) is a bitwise XORing of 2 words of k bits, which generates also a set of k bits and the k bits are represented by their decimal value, for instance. The inventor has created a computer program (in this case in Matlab) shown as Matlab screenshot in FIG. 13 that creates the bitwise execution and decimal representation of a function funbase by funn=elemtabn(dec, k, funbase, base). Herein funn is the decimal table representation of an elementwise application of a base function funbase applying a base to a word of k base-state elements into a table of dec-state elements. For instance, using base=2, funbase=xor2, k=2 and dec=4 (using Matlab origin-1) one gets sc4=[1 2 3 4; 2 1 4 3; 3 4 1 2; 4 3 2 1] in origin-1, which is of course an addition over GF(4).

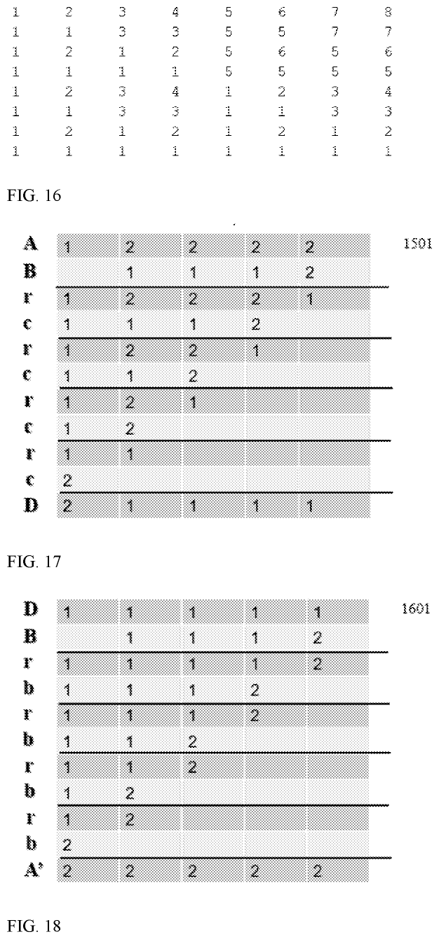

Similarly one may create the 4-state carry corresponding to sc4 which is reversible by car4=elemtabn(4, 2, and 2, 2) with car4=[1 1 1 1; 1 2 1 2; 1 1 3 3; 1 2 3 4] in origin-1. The carry free addition over GF(2\hat{ }k) has been modified into a reversible radix-n=2\hat{ }k operation with carry. The canonical form of the borrow is the flipped version of car4 or bor4=[1 2 3 4; 1 1 3 3; 1 2 1 2; 1 1 1 1], which one may also compute with bor4=elemtabn(4, 2, bor2, 2). One may apply the same approach for higher values like radix-8 or radix-256 or higher. For n=8 one gets car8=elemtabn(8, 3, car2, 2) as 8=2\hat{ }3 with results: car8=[1 1 1 1 1 1 1 1; 1 2 1 2 1 2 1 2; 1 1 3 3 1 1 3 3; 1 2 3 4 1 2 3 4; 1 1 1 1 5 5 5 5; 1 2 1 2 5 6 5 6; 1 1 3 3 5 5 7 7; 1 2 3 4 5 6 7 8]. FIGS. 15 and 16 provide the 8-state carry and borrow table that in combination with the standard addition over GF(8), create a reversible radix-8 operation. While there are certain state patterns that suggest reversibility, these patterns may differ as n increases. However, 2 patterns are the same: all carry (and borrow) functions/tables for n=2\hat{ }k have a row/column that has only zero elements and one row that is identity. Which means that both the n-state carry/borrow canonical transition tables for n being prime and for n=2\hat{ }k have a row/column that has only zero-elements. Thus, a transition table that has no column and/or row only being zero elements is NOT-CANONICAL.

For cryptographic reasons a radix-n operation with a transitional table that has a row and/or column of only zero-elements is less secure, because the reversible n-state operation of the radix-n operation is now transition free and at least may be somewhat open to attack. For that reason, an n-state transitional table in a radix-n operation preferably is non-canonical and preferably has no more than n/2 zero-elements in a row and/or column of its switching table. One is reminded that the zero-element is determined by the reversible switching function of the radix-n operation. Too many zero-elements again may offer an opportunity for attacks. For that reason, preferably one should generate a transitional table that has less than n zero-elements and preferably one makes sure that under the above condition no row and/or column has no more than n/2 or less than n/2 zero elements in a row and or column. Preferably, no row and or column has more than 2 consecutive zero elements.

Because one does not require in certain cases the radix-n operation to be reversible, a workable requirement may be to generate a random n-state transitional table/function with each element having an expectation of an 1/n expected occurrence. Another criterion for qualifying an n by n array of n-state elements is that the n by n array of n-state elements in combination with a reversible n-state operation configures or establishes a radix-n operation that is not reversible. A radix-n operation that includes an n-state reversible operation and an n-state transition function/table is not reversible or non-reversible when the radix-n operation of two words of two or more n-state elements each is not reversible for at least one set of two words. For instance, the operation may be reversible for one set of 2 words, but not for another one. In that case the radix-n operation is explicitly called non-reversible or “not reversible” herein.

FIG. 17 1501 illustrates a full radix-2 addition for 2 words of 4 2-state elements using reversible function such as 1401 (or XOR) and carry such as 1402. The operands A and B are words A=[2 2 2 2] and B=[1 1 1 2], all in origin-1. A and Bare selected so a maximum ripple of the carry is created. The small ‘r’ indicate the residue generate from the XOR of 2-state elements in that position. The small ‘c’ indicates the carry element in a position created by the carry function and2 (1402) on elements in a prior position. The operation in the example of FIG. 17 takes place from right to left. In the classical situation the last (or starting position of the carry operation) is empty, because there are no elements to determine a carry from. Or one may say that the carry in that position is always a zero-element. Moving from right to left as well as start with zero-element carry are arbitrary. One may start where desired. One may also assume that there are two (invisible) elements that are not zero-elements in the 5th element position. This means that there may be a non-zero element carry on a start position. For cryptography application one may assume that the carry-out and the resulting residue is lost and is not included in the computed sum D. Thus, while the bitwise XOR of A and B would be [2 2 2 1], the radix-2 result as illustrated is [1 1 1 1].

FIG. 18 illustrates the recovery of A from the result D which may be called a ciphertext and B which may be called a key by radix-2 subtraction of B from D, using again XOR (which is an involution) and bor2 as the 2-state borrow function, in table 1601. Again the borrow out is ignored and one recovers A=[2 2 2 2]

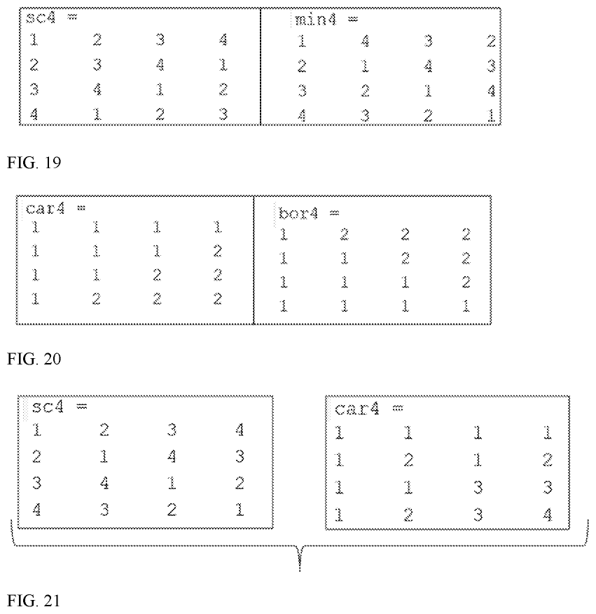

FIG. 19 illustrates addition modulo-4 sc4 and subtraction modulo-4 min4 in a Matlab screenshot in origin-1. FIG. 20 illustrates the carry and borrow functions related to the functions of FIG. 19. FIG. 21 illustrates a canonical 4-state carry function related to addition over GF(4) which in combination forms a reversible radix-4 operation. FIG. 15 further illustrates the canonical 8-state carry function corresponding in Matlab screenshot corresponding to the addition over GF(8).

A similar process may be applied to any radix-n operation using the correct reversible n-state function and the desired n-state transitional function. As explained above, a radix-n operation with an n-state reversible operation always has a uniform sum-space no matter the applied transitional function. Not all radix-n operations are reversible. However, as explained above, reversibility of the radix-n operation may not be needed, as in cryptography operations such as AES-GCM, ChaCha20 and/or hashing such as SHA-256.

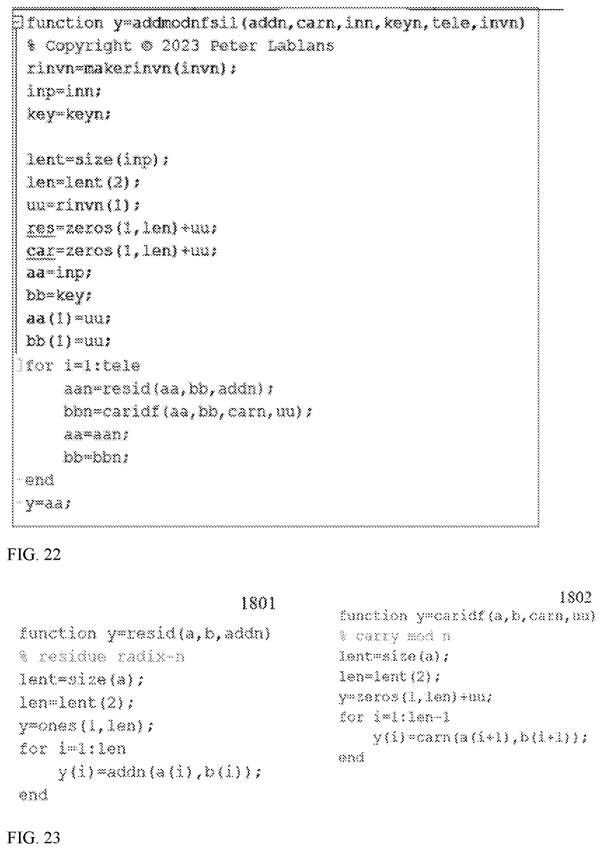

FIG. 22 is a screenshot of a Matlab program that performs a radix-n operation on a word of ‘tele’ rad-state elements with as input operands word ‘inn’ and ‘keyn’ and with reversible rad-state operation ‘addn’ and transitional array ‘cam.’ The term ‘invn’ is to further modify with an FLT, but for this purpose invn=[1 2 . . . n] or identity. FIG. 23 shows 1801 which is a screenshot of determining the residue and 1802 for determining the carry digits as used in the program of FIG. 22. As an example, one may create a radix-256 reversible operation on words of 4 256-state elements. The in256 and key256 may be generated in Matlab by in256=randi([1,256], 1, 4) and key256=randi([1, 256], 1, 4). To take care of the carry-out and borrow-out the program uses an extra digit at the input, which has no cryptographic significance and only the last ‘tele’ number of digits are significant. One may have: in256=[1 213 150 141 235] and key256=[1 74 194 193 98]. The reversible 256-state function is sc256=elemtabn(256, 8,xor2, 2) or derived from bitwise XORing of words of 8 bits in decimal form. Similarly: car256=elemtabn(256, 8, and2, 2) and bor256=elemtabn(256, 8, bor2, 2). This provides from sux=addmodnfsil(sc256, car256, in256, key256, 4, inv256) as ciphertext sux=[194 93 149 45 140] of which the first 256-state element is a carry-out and may be ignored. Reversing the radix-256 operation with dux=addmodnfsil(sc256, bor256, sux, key256, 4, inv256) dux=[194 213 150 141 235], which is the recovered input operand ‘in256.’ For the input of sux into the dux expression one may apply sux(1)=1 or any other dummy 256-state value, as that will not affect the outcome. For additions being derived from XOR, the addition and subtraction are the same as the function in that case is an involution, hence sc256 being used both in sux and dux expression.

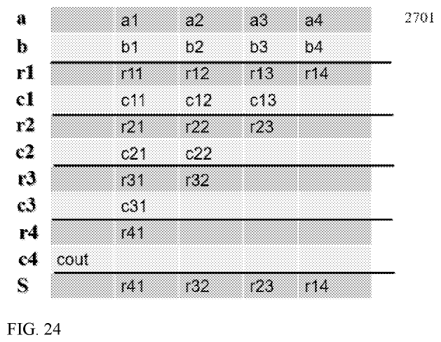

The above as well as a table 2701 in FIG. 24 illustrate a reversible radix-n operation on words of 4 elements. One may change the car256 to a random type 256-state 256 by 256 array by car256=randi([1, 256], 256, 256) which is definitely not a canonical transitional array for n=256. Applying this randomly generated carry or transitional function one gets sux=[87 191 137 27 140] using addmodnfsil routine. One may generate bor256, by flipping the car256 table. This generates dux=[11 21 172 96 235] which is of course different from the original input word in256. Because the last digit does not experience a transition or carry, the last digit is determined by the reversible function only. If that is a concern, one may stick an agreed upon but cryptographically unused help digit to the operand words to enforce a carry generated change.

One may call the above encryption modification encryption cloaking. One in essence maintains a data flow in an encryption, but modifies a function without modifying the sum-space or in other words without introducing a bias in the ciphertext. Thus, an attacker analyzing a ciphertext generated using the above steps is unable to derive from statistical properties of the ciphertext that a cloaking step was applied. This improves the security of the encryption when the modification is held as confidential. An additional benefit is that even when an attacker in some way has access to the keyword of an encryption, for instance acquired online and generated by PKI steps and cracked with a quantum computer, the attacker still will be unable to directly decrypt the ciphertext as the cloaking has further obfuscated the ciphertext. Encryption methods like AES-GCM and ChaCha20 have strong avalanche effects and even a small change in data generates a huge change in the output. Thus even a single cloaking step, for instance in only one AddRoundKey( ) step in AES-GCM or in a quarter-round of ChaCha20 will lead to tremendous and likely unbreakable change. In that case one should apply a cloaking step preferably in an early round of the total number of rounds.

The number of possible transitional arrays depends on n in radix-n. An n by n table of n-state elements has (n)\hat{ }(n\hat{ }2) different instances. For n=256 (using byte-sized words) one has 256\hat{ }(256\hat{ }2)=(2\hat{ }8)\hat{ }65,536 different instances or 2\hat{ }(8*65,536) or greater than 2\hat{ }500,000 or greater than 10\hat{ }50,000. Even with unusable arrays dropped (like all the same elements) this is a staggering number that may not be attacked successfully during the life time of the universe with all computer power available. In a current situation where “harvest now, decrypt later” attacks are already taking place, the above simple but highly secure modification may be a very effective way of Cloud customers to provide additional security for Cloud residing data that benefits from extra security.

The above was illustrated with 4 8-bit words. This may be convenient for instance for an AES state array which is a 4 by 4 array of bytes. It should be clear that one may arrange this in different word sizes as well in different n-state symbols. For instance, the AES state array may be treated as a single word of 32 bytes and create a radix-256 operation on 2 words of 16-bytes or treat the AES state array as 2 words of 8 bytes. One may then apply different random or random-like 256-state transitional (carry) functions or tables. The 16 bytes in an AES state array are 128 bits. One may create for instance elements of 10 bits (1024-state element) and create a word of 5 1024-state elements and treat the remaining 78 bits as individual bits to be XORed. Or any other combination of words and n-state elements.

One may consider words of elements of 16 bits or greater. A practical problem for some cases is the size of the related transitional n-state table. However, some functional steps may be applied to implement seemingly random-like n-state transitional tables. For instance, one may generate and store an n-state vector or 1D array and create a rule for a transitional n by n array that adds to a content of the vector the index of an operand modulo-n which provides a cyclic effect. One may also shift the vector one or more position alone or in combination with a mod-n addition or any other repeatable rule.

For instance, in ChaCha20 as well in hashing such as SHA-256 and other cryptographic operations one may do an addition mod-2\hat{ }32. This is performed as a binary addition with as max result a word of 32-bit of is after which the cyclic character of mod-n addition kicks in. One may modify the addition mod-2*32 into a radix-256 (or other) addition with a random or random-like transitional function/table. Instead of doing a 32-bit radix-2 addition one then takes each 8 bits as a 256-state element and the 32-bit word is then operated on as a 4-byte word. Doing a 4-byte radix-256 standard addition will of course generate the same result as a 32-bit radix-2 addition, because only the radix has been modified. However, by modifying the related 256-state transitional array in a radix-256 operation to a non-reversible random or random-like 256-state array, the sum of the radix-256 operation (combining 2 words of 32-bits in a quarter-round in ChaCha20 for instance.)

In the context of the above, which may be called encryption cloaking by radix-n modification, the introduction of a random or random-like n-state transitional function/table may render the radix-n operation non-reversible or irreversible and in a cryptographic sense an original state is not recoverable from such an operation. In for instance AES-GCM, ChaCha-256 and others that is not a problem, as the operation of which the irreducible radix-n operation is part of is a one-way operation anyway. It should be repeatable, for instance to generate a keystream, but bot reversible. This is where many of the AES modes are different from AES-GCM as each step in the reversible AES have to be really reversible. But that is not the case in AES-GCM where AES is used to generate a keystream. Herein a non-reversible n-state transitional function or table, means that it is to be used with a reversible n-state operation for residue generation but that the inclusion of the n-state transitional function or table renders the radix-n operation non-reversible. The n-state transitional array may be invertible in a linear algebra sense, but the corresponding radix-n operation is non-reversible. Thus, the term n-state non-reversible transitional function or table in a radix-n operation means that the radix-n operation is non-reversible.

It has been shown above that one may create what is called a radix-n operation on words of k n-state elements with n>2 and k>1 including an n-state reversible residue operation and an n-state transitional operation. The residue operation creates an n-state residue element that may assume each one of n states. The transitional operation creates an n-state transitional element that may assume each one of n states. During processing an n-state residue element and an n-state transitional element are processed by the n-state reversible residue operation.

It has been shown herein that for residue operations being modulo-n additions or FLT thereof the radix-n operation is reversible for a transitional function or operation and the transitional element having one of any of n states. This is different from accepted practice wherein the transitional element has only one 2 possible states. The reversing radix-n operation is formed by the reversing operation of the residue operation and a flipped version of the transitional function. A reversible radix-n operation whereof both the residue and the transition function are FLTed with the same FLT is also reversible.

Additions over GF(n=2\hat{ }k) are carryless operations. An n-state carry function has been provided that in combination with an addition over GF(n=2\hat{ }k) which may be formed by XORing of 2 words of k bits creates a reversible n-state radix-n operation. FLTing the addition over GF(n=2\hat{ }k) and the carry function creates a new reversible radix-n operation. Like the novel involution provided herein, it provides additional security to cryptographic operations, especially when FLTed with a confidential or secret FLT.

The inventor has provided the concept of sumspace and has shown that any reversible n-state residue function in combination with any random n-state transition function creates a radix-n operation with a flat or uniform sumspace or outcome space, and will not show any bias. A random n-state transition function is a 2-operand n-state function wherein an outcome of two n-state input operands may provide one of any of n states. Such radix-n operations are generally not reversible. However, many hash and keystream operations are one way, in the sense that computation of a reverse or inverse is not required. Repeatability and non-bias are generally required, which the radix-n approach provides.

An aspect of using XOR in machine cryptography is that it us mostly used to enter data or output data in a cryptographic system or device. It does so in encryption/decryption and hashing, for instance. It has been widely studied as such and has been in use already a century ago in the Vernam Cipher. Its benefit is its balanced and reversible nature. However, by itself XORing, provides no cryptographic security, which usually comes from other processing steps and/or secret key streams.

An ability to apply n-state transforms and/or entirely different n-states functions that may be involutions and/or do not introduce bias, and have extremely large variations, that work on words of bits and large words of bits, from 8 bits words to 32 bits words to words of 1000 of bits or larger actively contribute to security of computer implemented cryptography. Another factor that contributes to security increase, is that transforms may be inverter based which by itself offers an immense solution space, enabled by combinatorial explosion. It was shown that self-propagation enables variations that may be implemented real-time, for instance in existing cryptographic primitives generally widely known in the art of cyber security. One may update real-time an n-state inverter by self-propagation on a session, message, file transfer, packet, block and round level in an implementation of a computer function. It enables a real-time secret transformation that establishes real-time secret agility as currently promoted and pursued in cyber security.

Different ways to create n-state reversible inverters have been disclosed. The n-state reversible inverters have a size (n n-state elements) that may be expressed in bits. An n-state element may be represented by k bits. In that case an n-state reversible inverter has a bit equivalent size of n*k bits. The n-state reversible inverter, which may be a seed inverter for a self-propagating reversible inverter, is created from initiating data, which is preferably secret data, that is in size smaller in bit equivalent size than the n-state reversible inverter it generates. In one embodiment, the initiating data is stored confidentially on a computing device. In another embodiment, the initiating data is computed from key exchange or PKI data. That is a shared key, which may be a PKI key, is computed and at least some of that shared key is applied to generate an n-state reversible inverter. The shared key may be a PQC key such as Kyber as defined in NIST FIPS 203. Kyber has a size of 32 bytes. A 256-state reversible inverter has a size of 256 bytes.

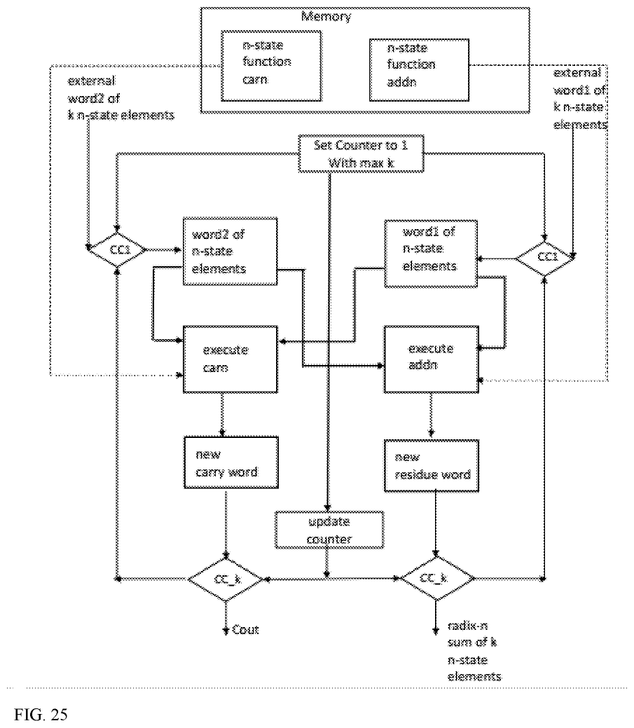

FIG. 25 illustrates a dataflow as implemented by instructions as shown in screenshot of FIG. 22. The instruction y=addmodnfsil(addn, carn, inn, keyn, tele, invn) requires that the dataflow is provided with addn (for residue) and carn (for transition element determination) and inn and keyn are two n-state words of tele n-state elements, generating a result or sum of tele n-state elements. FIG. 25 illustrates that addn and carn are retrieved from memory. The rippling of the transition through the operation requires tele steps, including for each step determining a new word of n-state residue elements and of n-state transition or carry elements. A counter is initiated at 1 and set at maximum tele. A test CC1 (for cycle counter CC1) determines if the counter is 1 or not 1. When CC1=1 the new words word1 and word2 are entered. When CC1≠1, the newly generated residue word and transition word are applied as active words. The functions addn and cam are applied to corresponding elements of the active words. After execution of addn and cam, a processor updates the cycle counter and CC_k checks if the maximum count=tele has been surpassed. When not, a next cycle is performed. When CC_k>tele the end result has been achieved and is provided as final residue word of tele n-state elements. A final (potentially unused) transition n-state element Cout may be available. The flow of FIG. 25 corresponds to the illustrative diagram of FIG. 24, which is an illustration for the operation for tele=4.

In accordance with an aspect of the present invention, one may FLT the ‘+‘operation with its own rule based n-state inversion ind_plus=aa_plus*x+ss_plus and its corresponding reversing inverter. One may also replace ‘+‘with the bitwise XOR of the two operands like: ginv=aa⊗g⊕ss. This makes the reversing inverter simpler as x=aai⊗(ginv⊕ss).

An effective “inversion” is a change in the representation of a key or common key in an encryption. One may agree for device 1 and device 2 to use a common modification of a 256 bit word. The common key is represented as 256 bits with leading zeros if need be. Both devices already have achieved a common key even before reverse inversion, for instance via PKI. One may do the additional inversion before or after or even instead of the reverse inversion. Such an inversion may be one way, but may also be reversible, even though there is no need for reversing it. As an illustrative example, one may use: take the 256 bit sequence and shift it k bits in a circular way. For instance, take k bits from the left side of the sequence and place them on the right side of the sequence. Then cut the shifted sequence in m equal parts. And then, for instance starting from the back forward, form a new sequence by taking a bit from each part and place them in consecutive positions in the new sequence, moving through the parts until all bits have been placed.

The inverter ‘invn’ is reversed by reversing inverter ‘rinvn’ which may be obtained for instance by the rule rinvn(invn(x))=x. Of course, rinvn and invn may be switched in meaning, so rinvn is the inverter and invn is the reversing inverter. One may apply this type of inversion on key generation, such as Diffie Hellman, classical and elliptic curve based, on RSA and ElGamal as well as others including post quantum PKI.

The AES based instructions in AES-GCM/CTR are used to generate a keystream and need not to be reversible. AES has several steps. One is the Key Expansion which applies the key of 128 or 256 bit to be expanded for instance in a key array of 240 bytes. A key array is used from the key expansion as a round key. Each round in AES is applied to a state array which is an array of 16 bytes commonly represented as a 4 by 4 array of bytes. Each round also use a round key of 4 by 4 array or 16 bytes. In the applied program, the state is represented as a 256-state element array.

In one example, the 4 by 60 (=240) 256-state array of the key expansion created in one mode of AES, is shuffled by a 240-state reversible inverter created by inv240=randperm(240) for instance in Matlab. The shuffling is executed by first creating a first single row array of 240 elements from the array, then creating a second single row array wherein element of the first single row array (i) are moved to position ind=inv240(i) in the second single row array and the second single row array is converted back to a 4 by 60 array.

In an illustrative example the 240 byte key expansion array is generated from the following 256-bit key (or 32 bytes) key=‘44a74cla57da2bf6d6838956cdca13f1b67cc6ad87d459bff544784083868171’.

The output in Matlab of the array is a 4 by 60 256-state array, but is too large to be shown herein in its entirety. For illustrative purposes only the first part being 4 rows with 10 columns of the generated Key Expansion array is shown in a screenshot outputted by a Matlab program in FIG. 7.

In accordance with an aspect of the present invention the 256-state elements of the array are being shuffled based on reversible 240-state inverter inv240=[123 99 174 32 40 22 175 . . . 57 122 10 12 226 118] of which only the first and last 7 elements are shown as 256 elements would just confuse by its large number of elements.

A ciphertext generated without shuffling may be:
C=‘6deb6e66165c0f8d85369bb6d2051d’ in accordance with an example. Using the shuffling of 256-state elements with an inv240 generates ciphertext
C=‘9fe6d6dfebada5923e998245142996’. This demonstrates the security effect of n-state inverter based k-state element shuffling.

The modifications as disclosed herein affect the generated ciphertext in AES, AES-GCM, ChaCha20 and the hash in SHA-256, SHA-512, SHA3 and Keccak versions.

### Permutations

Another way to ensure self propagation in a large possible way is to apply lexicographical permutation starting from the seed inverter. For instance, Knuth's Algorithm works well. While it works in a systematic way, the results are unpredictable because the seed is secret. Others include Myrvold-Ruskey Algorithm and Myrvold-Ruskey Algorithm, for instance. Assuming that the seed inverter is secure or secret, the follow-on permutations are also secret. A setback may be that a single step permutation does not create sufficient change. In that case one may divide an n-state inverter, for instance, in p parts of k n-state elements and permutate the parts based on a pre-agreed rule and then re-assemble the permutated parts again into an n-state reversible inverter.

One may apply a similar method of shuffling and/or inversion to all or part of the ChaCha20 encryption method. For instance, in ChaCha20 as defined in for instance RFC 7539 which is assumed to be known to one of ordinary skill, the state array is a 4 by 4 array of words of 32-bits. The second and third row of the state array are formed from a 256-bit key. For each block of plaintext that is to be encrypted the same input state array is applied, except for a counter word which is updated for each block. One may shuffle or invert any word of withs or series of words as desired by the aspects of the present invention, disclosed above herein. Considering the possible variations, it seems worthwhile to shuffle at least 128 bits or perhaps a row or a column of a ChaCha20 state array. As in AES-GCM, the state array is used to generate a keystream and needs not to be reversed. If one doesn't want to change the binary distribution of bits in a state array one may stick to shuffling.

One may apply the inversion, and/or shuffling and/or FLT on a block of a message that is encrypted and also on a packet of a Virtual Private Network (VPN) and of course on each of a plurality of messages in a (seemingly continual) exchange of data by multiple messages. One may also update the n-state inverter for each block in the manner of a self-propagating n-state inverter. For ChaCha20 and its variants, one may also n-state invert more than only the counter as described above. One may invert one or more of the nonces or of the constants or even the key. As long this is done in a repeatable and agreed upon way, one may apply it in both encryption and decryption.

The above shuffling and/or inversion methods also apply to hashing such as SHA-256/SHA-512 and SHA-3 and SHAKE and others. Certainly, SHAKE and SHA-3 use large state arrays and several rounds (24 in SHA-3). SHA-256 operates on blocks of 512 bits and SHA-512 on blocks of 1024 bits which may be inverted and/or shuffled in one or more rounds and other modifications as disclosed above. Similarly, one may shuffle/invert the 256 bit output of SHA-256 and the 512 bit of SHA-512. This creates private or customized hashing. A similar modification may be applied to known signature methods in data exchange or to internal sequences or data series or blocks or words or bits that are processed.

Encryption, decryption and hashing are all used in different computer applications that require security and include: data transmission and data storage, for instance in Cloud based applications and data storage. It may be applied in VPN as already indicated. In credit card security. In Network Security Protocols. In authentication protocols. In Bluetooth and other wireless communications. In cellular phone communication. In WiFi communication. In scanning apparatus. In file sharing. In end-to-end encryption. In signal distribution. In data distribution such as updating data and/or programs. Computer based cryptographic methods are applied so ubiquitous as impossible to list all individually. In this AES and SHA (both old SHA and newer SHA-3 and variants thereof) are the dominant applications with ChaCha20 and its variants also widely applied. These all may be modified with aspects of the present invention as described herein.

The above applies to direct modification or transformation of data. It may also be applied to functional transformation. For instance, one may apply the self-propagating inverters to the inverters that are applied to an FLT as illustrated in FIG. 1. This means that one may FLT the functions in for instance AES and/or ChaCha20 and/or hashing such as SHA-256 and SHA-512 and/or SHA-3 in a virtually infinite (well billions) number of instances of modified cryptographic primitives. In fact, every modification that applies the FLT may be supported by such self-propagating inverters.

The inventor teaches and discloses in U.S. patent Ser. No. 18/908,321 (the “321 application”) to Peter Lablans filed on Oct. 7, 2024 which is incorporated herein by reference, a computational function transformation by including and/or modifying an n-state carry generating function, which is preferably random-like in appearance. To briefly re-explain how that works the example of byte-wise XORing as applied in AddRoundKey( ) in AES-CTR and/or AES-GCM and/or ChaCha20 will be used. That example is used because it uses a one-way repeatable approach for generating a key-stream. But its application in hashing is also one-way. For instance, the AES part in AES CTR/GCM is used to generate a keystream applied both in encryption and decryption. The inventor recognized that this allows the use of one-way functions in AES, which otherwise are reversible operations. AddRoundKey is an example of that. In fact, AddRoundKey is an involution as both encryption and decryption applies the same functionality.

AddRoundKey( ) in AES as set in FIPS-197 is a bitwise XORing of words of bits in a 4 by 4 byte array in the Key Expansion array and the 4 by 4 byte State Array, as one of ordinary skill in cryptography knows. FIPS recommends XORing corresponding columns in the two arrays. Whether it is done by rows or columns doesn't matter as the XORing is a carry-less bitwise operation. The inventor gave it a unique twist by considering the byte-wise XORing as being represented by an addition over GF(2\hat{ }8=256). The 321 application then does a computational function transformation, by transforming for instance the addition over GF(256) of 4 256-state elements (the 4 bytes in a column of an array) as a radix-256 carry propagating operation. The radix-256 aspect indicates that the addition (like a carry ripple addition) has a repeat of two parts: 1) generate a 256-state residue of 256-state elements in augend and addend, followed by determining carry elements, and creating a new residue until no more carry elements are propagated. This causes the carry to ripple through the partial sums, hence the name carry ripple addition.

The 321 application applies a completely random or random-like carry function, which may in the 256-state case be a 256 by 256 256-state lookup table, wherein the elements may be any of 256 states. This is of course different from the standard carry ripple adder wherein the carry is only 0 or 1 (when working in origin-0). The 321 application explains that this approach does not change the distribution of the outcome sum, which remains flat or uniform over all possible outcomes when using all possible input operands. This is called a flat or uniform sum-space. The only requirement is that the residue function absolutely must be an n-state reversible function.

There is an immense number of possible outcomes. In accordance with an aspect of the present invention one may apply any n-state carry function in a radix-n addition and still maintain a uniform sum=space of the modified radix-n addition as long as the n-state residue function is reversible. Expressed in possible n-state n by n carry table one gets the astonishing number of (n\hat{ }(n\hat{ }2)) different carry functions. For n=256 this is beyond astronomical 10\hat{ }150,000 different tables. These include of course minimally modified tables. Practically one may expect the still astonishingly large number of 10\hat{ }1500 different 256-state carry function tables. Practically one may start with a pre-stored 256 by 256 256-state carry table that may be randomly generated and transform dynamically with either a 256-state inverter or a 65536-state inverter shuffle or an FLT.

While one may keep using the carry propagating addition of 4 bytes (like the columns of the state array) one may expand it to 2 columns or 8 256-state elements or even addition of 16 256-state elements. Furthermore, one may apply this function transformation to all rounds or a single round or 2 or more rounds. One may apply different carry tables if one desires.

A practical issue may be to store different 256 by 256 state 256-state lookup tables. Such a table has 256*256 or 65536 256-state elements. In accordance with an aspect of the present invention, one or more self-propagating inverters are used to generate different carry tables. An original table may be stored as well as self-propagating inverters. The self-propagating inverter may be a 256-state inverter, which inverts the elements of the carry lookup table. The lookup table may be represented as a one dimensional array and shuffled. One may shuffle all the elements of the table with a 65536-state inverter or just parts of the array. One may also use techniques like using different state elements by using different word sizes as explained above. One may apply one n-state self-propagating inverter which preferably generates billions of unique inverters and use that to extract smaller state inverters. Or one may use 2 or more different self-propagating inverters to perform the modifications.

One may use the generated different inverters also as required elements in an FLT of an n-state operation. This may include the word-based XORing or any mod-n addition or n-state operation that is FLTed. These examples are the simplest to follow for illustrative purposes.

It was already explained that one may use self-propagating inverters to perform the element inversion and/or shuffling. This prevents the need to store massive numbers of inverters for encryption of plaintext that has many blocks. For each block one may apply an inverter that is generated from the base inverter in a self-propagating chain. This has further benefits, as one may re-use these inverters by applying a different starting point. This creates different inverters for blocks of plaintext that are in identical block positions.

Preferably, one applies stored n-state base inverters that are used as self-propagating inverters. One may also generate n-state inverters that are derived from the secret parameters of encryption such as the key in AES and ChaCha20 and other encryption and hashing methods

A difference between keys and n-state inverters is that 1) keys and n-state inverters may have different sizes, even in bit representation; and 2) a key, even of same size may have certain n-state elements more than once appearing or even not appearing at all in the key. In an n-state reversible inverter all n-state elements appear exactly once. A first step to create an n-state reversible inverter from a smaller n-state sequence in accordance with an aspect of the present invention, is to expand an existing or computed key to the required size commensurate with the n-state reversible inverter. There are many secure algorithms that do that. One way is using a hash like SHA-512 and do a repeat hash on generated hash and concatenate all hashes until the desired length is obtained. For instance, 8 SHA512 hashes will generate 8*32 bytes in concatenated hashes which represents 256 256-state elements.

In accordance with an aspect of the present invention, a hexadecimal sequence of 256 bytes is converted into a sequence of 256 256-state elements. One then organizes the sequence in two representations such as arrays. A first array with rows with row index k starting with the corresponding 256-state elements followed by all positions that it occurs. So when the element 33 occurs 4 times in positions 4, 19, 101 and 233 it shows [33 4 19 101 233 0 0 0 0 0 0](Matlab does this simply with the ‘find’ instruction). For convenience the related element 33 is shown in position 1. The 0 indicating not occurring. Element 154 which may not occur at all has [154 0 0 0 0 0 0 0 0 0 0], with again the element itself showing in position 1. Also, a second array or sequence of elements that do not occur in the expanded sequence is created. The inventor created a Matlab program that goes through the arrays in the following way: it selects the first element that does not occur from the second array and goes to the first row in the first array that shows more than 1 occurrence of an element and replaces the second (or later the ‘next’) occurrence with the non-occurring element. After replacement the replaced position itself is replaced with a blocking code that indicates that the position is no longer available for replacement. The program thus works itself through the list of non-occurring elements in the second array, until all multiple occurrences beyond once are replaced with previously non-occurring elements. The inventor implemented this in Matlab. One can make several variations of the above, all with satisfactory results.

This works well as demonstrated by the following for a 25-state sequence:
seq25=[23 9 24 24 15 3 10 7 7 6 1 23 12 15 8 25 25 25 17 19 9 14 7 18 20]

A Matlab procedure named inv25=createReversibleInverter(seq25, 25), then creates inv25=[23 9 24 16 15 3 10 7 2 6 1 13 12 11 8 25 21 22 17 19 5 14 4 18 20].

Comparing the two (seq25 and inv25) shows how it works. One may modify the order, for instance always changing the first element in duplicates and maintaining the second occurrence. Other are possible and fully contemplated. One may check the correctness in Matab by doing a sort(inv25) which should be an identity. For very large sequences, such as n=256 or longer, one can check by generating test=1:n and then doing isequal(test,sort(invn)).

There are many different ways to generate k-state reversible inverters from a sequence of k-state elements in which elements occur more than once. The program of FIG. 11 is an illustrative example. One may generate different k-state reversible inverters from the same sequence of k-state elements. One may start replacing duplicates from the back of the sequence, moving forward. One may remove from the sequence of n-state elements all duplicates and create a sequence of k unique n-state elements, and determine the missing n-state elements. One may insert the missing n-state elements for instance from the back of the sequence of k n-state elements and insert the missing elements ordered in an ascending way, by interleaving a missing element between two unique n-state elements.

A feature of earlier above taught approaches is that in a first embodiment a reversible n-state inverter with an equivalent full or complete size k1 bits is generated from secret and/or cryptographic data with an equivalent size of k2 bits and k1>k2. In a second embodiment a reversible n-state inverter with an equivalent complete size k1 bits is generated from secret and/or cryptographic data with an equivalent complete size of k2 bits and k1=k2. In a third embodiment a reversible n-state inverter with an equivalent full size k1 bits is generated from secret and/or cryptographic data with an equivalent size of k2 bits and k1<k2. For instance, one may use a secret key which may be a secret PKI to generate a secret and secure shared reversible n-state inverter, with n preferably greater than 2, more preferably greater than 127 and most preferable greater than 255.

A complete reversible n-state inverter, as used herein, is the full representation of a reversible n-state inverter comprising n n-state elements. Stated differently, the complete representation is a sequence of n elements, each element having one of n possible states. To provide a common quantitative measure for such sequences, the concept of binary cardinality is introduced. The binary cardinality of an n-state reversible inverter is the size, in bits, of a binary representation of the inverter including all of its n n-state elements.

For example, a complete 256-state reversible inverter includes 256 elements, each of which requires 8 bits to represent, yielding a binary cardinality of 256×8=2048 bits. Thus, the binary cardinality of a 256-state reversible inverter is 2048 or 2048 bits. For values of n that are not powers of two, the binary cardinality exceeds the strict minimum because binary encoding requires representation in powers of two, making some excess representation unavoidable.

For very large n, such as n=2\hat{ }100, it is generally impractical and unnecessary to store or enumerate all 2\hat{ }100 elements explicitly. Preferably, a rule-based inverter is used to generate individual elements on demand, as disclosed herein. Nevertheless, the binary cardinality of such an inverter remains well-defined and equals 2\hat{ }100×100 bits.

The concept of binary cardinality may likewise be applied to any sequence of data elements, whether or not the sequence forms an n-state reversible inverter. For example, a shared PKI key comprising 32 bytes has a binary cardinality of 256 bits. As another example, a set of four 16-state elements defining a 2×2 array of 16-state values—usable as a generating rule for a 256-state reversible inverter as described elsewhere herein—has a binary cardinality of 4×4=16 bits. This generating rule, despite its binary cardinality of 16 bits, produces a complete 256-state reversible inverter having a binary cardinality of 2048 bits.

There are different ways to activate the above security improvements. One way is to let all data leave a private network into the cloud or enter a private network from the cloud though a computer or network server behind a fire-wall. This server or computer may have pre-programmed the required parameters. One may create a coding scheme that determines what modification parameters are used and how they are applied, including initial settings, rounds to be affected. which function or multiple functions are transformed, derivation of expanded keys and inverters and the like. This may form a vector of numbers and/or codes that indicate a variation. For example a code of which a hash may be created indicates [5, 4, 9, 22, . . . ] and means using 5 iterations of a self-propagating inverter (code 5), to modify with FLT AddRoundKey bitwise XOR (code 4), in round 9. for block 22 in AES-GCM. The length of the code interpretation can be a vector of up to 100, 1000 or even 10000 meaningful elements. They may be managed by a Key Management System. For computers somewhat unknown connected via an application, one may share procedures using the codes but that may use PKI based key exchange to derive required parameters such as inverters from secure keys, as disclosed herein.

The herein taught modifications in general preserve an architecture of proven and well tested cryptographic devices and methods. They modify the implementation of such architecture in that the numerical output of the related transformed cryptographic operation is modified with a factor of change that may be an astronomical factor 10\hat{ }500 or greater. The modification, due to preserving the base architecture does not leak or reveal itself in the output such as plaintext or hash, which will preserve its statistically random character.

The herein disclosed modified and novel computer functionality is expressly used in cryptographic modification of data signals transmitted between at least 2 different computing devices. The cryptographic application may be an encryption, a decryption, a hashing, a digital signature generation and/or a digital signature verification. Data is processed in a first device and then in its processed form transmitted to a second device. This may be as simple as a local computer using a processor (the first device) with memory to create encrypted data or a hash, and transmit the encrypted data or the hash to a storage device like a hard disk or a flashdrive which may be removable. It may also be that the processed data (ciphertext and/or hash and/or signature) is transmitted via a network to a remote device such as a server or a receiving computer. A computing device may also receive processed data or retrieve data from another device and processes the received data to for instance decrypt encrypted data and/or re-computes a hash and compares it with a received hash and/or verifies a signature accompanying a digital file, or any other relevant cryptographic operation.

The cryptographic operations and devices as described herein provide security in data storage, reception and transmission between computing devices. Furthermore, the requirements of speed of exchange and the limited waiting time that is available, the devices and/or methods as taught herein work with a speed equivalent to processing at least 1000 bits per second and preferably much faster. There are several measurements known in the literature. For example, using hardware acceleration (such as Intel's AES-NI), AES-128 can achieve speeds of around 3 GB/s. This means that encrypting a typical internet packet (which is around 1,500 bytes) would take approximately 0.5 microseconds (0.0005 milliseconds). The required speed as well the requirement to transmit the cryptographic data between computing devices over a physical channel, preferably an electro-magnetic field enable channel, or even a quantum-mechanical enabled channel, requires processing speeds that cannot be achieved reasonably by any human or even multiple humans even when using paper and pencil. The herein disclosed and later claimed aspects of the present invention pertain strictly to machine or computer executed functionality.

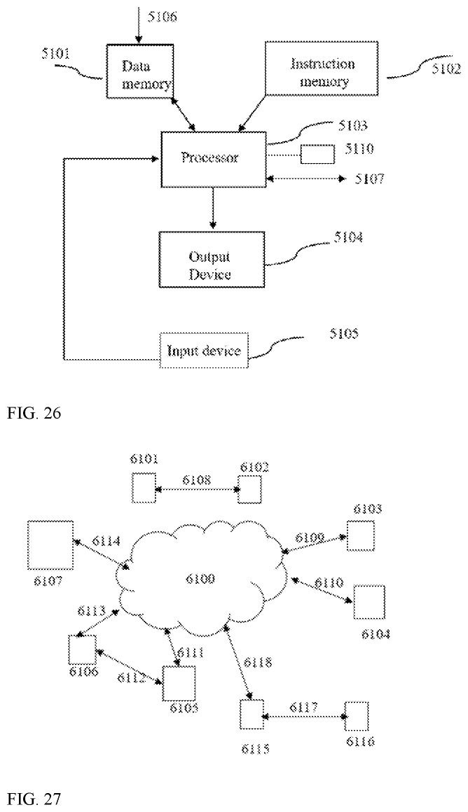

A computing system illustrated in FIG. 26 and as described herein is enabled for receiving, processing and generating data. The system is provided with data that can be stored on a memory 5101. Data may be obtained from a sensor or may be provided from a data source. Data may be provided on an input 5106. The processor is also provided or programmed with instructions executing the methods of the present invention is stored on a memory 5102 and is provided to the processor 5103, which executes the instructions of 5102 to process the data from 5101. A processor may be a programmable processor, it may also be a fixed program processor. A processor may have multiple processing cores. And while the processor is represented by a single box, it may be a combination of a CPU and one or more assists like a GPU or nowadays NPUs or neural processing units. Data, such as an image or any other signal resulting from the processor can be outputted on an output device 5104, which may be a display to display data or a loudspeaker to provide an acoustic signal. The processor also has a communication channel 5107 to receive external data from a communication device and to transmit data, for instance to an external device. The system in one embodiment of the present invention has an input device 5105, which may be a keyboard, a mouse, a touch pad or any other device that can generated data to be provided to processor 5103. The processor can be dedicated hardware. However, the processor can also be a CPU or any other computing device that can execute the instructions of 5102, including FPGAs and discrete components. The processor 5103 in some embodiments has integrated or connected to it communication circuitry 5110 with a customized physical interface. A customized interface may be a connector, an antenna, a reader or read/write interface or any other physical interface to transmit and/or receive signals to or from an external device. Accordingly, the system as illustrated in FIG. 26 provides a system for data processing resulting from a sensor or any other data source and is enabled to execute the steps of the methods as provided herein as an aspect of the present invention. This is a illustrative example of a computing system. One may also have a computing system that is a dedicated custom circuit with discrete components either of a circuit board or on an integrated circuit. The system may also be realized as a Field Programmable Gate Array or ASIC or any other circuit that performs computing capability.

A computing device or system often works in a network or interconnection. FIG. 27 illustrates a possible network configuration. FIG. 27 has a communication network 6100. Network 6100 may be a single network such as a wireless or wired network or a combination of networks such as the Internet. The network may be a switched network or a packet based network, a private network or a public network or a virtual private network or any other communication network that enables connection of 2 computing devices and of 3 or more computing devices. In one configuration two computing devices 6101 and 6102 with communication circuitry to transmit, receive or transmit/receive signals are provided. The communication circuitry of 6101 and 6102 can transmit signals over a channel 6108. The channel 6108 is identified as a double arrow. This indicates that the channel is bi-directional, but it does not necessarily mean that 6101 and 6102 do both have to transmit and receive, though they may. For instance, 6101 is an opening device or a smartcard or any other transmitting device and 6102 is a computing device that is part of an access mechanism that is being activated by one or more signals from 6101. Device 6101 for instance has cryptographic circuitry that generates opening signals that have to be detected and decrypted by 6102. For that application wherein each device has the appropriate instructions and data stored to complete an authenticated transaction, like opening. In one embodiment of the present invention there is thus only one way transmission by 6101 and receiving of data by 6102. The channel is a direct channel, like a wireless or wired or Near Field Communication (NFC) channel, a USB connection, a Bluetooth connection or any other direct connection. For the transaction itself no other channel is required. The devices 6101 and 6102 may have other communication capabilities, such as equipment to connect to network 6100, but are not shown. Devices 6101 and 6102 have different modified n-state switching functions stored on local memory. These may be updated from time to time.

Devices 6101 and 6102 may also perform some mutual authentication or for instance key exchange. In that case 6108 is a dual use (send and receive) channel and the devices 6101 and 6102 both have send and receive equipment. The same applies to devices 6103, 6104, 6105, 6106, 6107 and 6115 and 6116 and communication channels 6109, 6110, 6117, 6118, 6111, 6112, 6113 and 6114.

In one embodiment of the present invention 6115 may be a gateway server and 6116 may represent one or more devices connected to the cloud through gateway server 6115 that may implement machine cryptography as disclosed herein.

Computing devices 6103 and 6104 communicate with each other via channels 6108 and 6110 via network 6100. Cryptographic n-state switching functions may be stored locally and may be provided by secure server 6107 which is connected to network 6100 via channel 6114.

Device 6115 and 6116 communicate directly via a channel 6117. Device 6115 is also able to communicate with secure server 6107 via channel 6114. Devices 6105 and 6106 can directly communicate with each other over channel 6112 and with server 6107 via 6100 over channels 6111 and 6113, respectively. As needed 6105 and 6106 can also communicate via 6111 and 6113 via network 6100. Any of the communication channels, even though illustrated by double sided arrows may be single direction as dictated by practical circumstances.

For instance, devices 6115 and 6116 communicate directly via 6112 to complete a transaction, such as withdrawing money from an ATM 6115 machine with a smartcard 6116 and 6115 uses 6118 for verification from 6107 via network 6100. Assume 6116 to be a chipcard or smartcard which is connected to 6115. During an established connection 6116 can be updated with additional or replacement modified n-state switching functions.

Computing devices can be mobile or fixed. For instance, 6103 and 6104 are two computing devices that are connected to the Internet, for instance 6103 is a computer, such as a PC, a smartphone, a tablet and 6104 for placing an order and 6104 is a server for processing the order. For instance, 6103 is a computing device which may be a server, a computer, a PC, a smartphone, a tablet, a processor and the like to monitor and/or control an IoT (Internet of Things) device 6104 with a processor such as a camera, a medical device, a security device such as a lock or fire monitor, a thermostat, an appliance, a vehicle or any other device.

Terms like hash, signature, ciphertext, plaintext and the like have been used herein. The purpose is to describe the role of the related data. But these are of course in the sense of computer technology messages or signals that are being transferred between computing devices generally connected through a network. However, data or messages may also be carried on a storage device, such as a memory stick, a hard drive, an optical drive a portable device such as a laptop or a smartphone or a tablet and transferred from these devices to another device. Machine cryptography as described herein is applied to protect security and/or authentication of messages, data and/or devices.

The article “a’ herein means “one or more” unless explicitly used to mean one (1). Without such an explicit designation “a” means one or more.

A memory herein is a technical device that stores data that may be retrieved from the memory by a processor. A memory may be permanent such as a Read Only Memory, a programmable memory a random-access memory, an addressable memory or any other device that is used to store data and retrieve data from. That includes devices that may also be named storage devices such as tape drives, magnetic disks and optical disks for instance.

Cryptography as applied herein is machine or computer implemented cryptography. It processes data into cryptographic data that may be captured and/or processed by unauthorized machines or computers. The size of data, such as messages or files, is such that processing by hand of this data with required speed and volume, even with many people even with using paper and pencil is practically impossible. For instance, one may require a processing speed of at least 100,000 8-bit equivalent symbols per second. Furthermore, the herein described cryptographic methods make it infeasible to effectively and successfully recover the hidden information from transmitted data within at least 100 hours of computer based attacks. The herein disclosed methods and devices ensure security of transmitted data and/or validates the origin of the cryptographic data.

Machine cryptography generally involves at least two computers, although one may also encrypt data on a single machine. There may be a sending or transmitting machine, that encrypts data and/or makes a hash of data and transmits data with a hash, and there is a receiving machine that receives data from the sending computer such as ciphertext and/or data such as a hash to validate or authenticate the received data. In one or more initial steps, the receiving machine may receive data, like Public Key Infrastructure or PKI data that allows the receiving machine to compute a shared key, such as a PKI Kyber key in accordance with NIST FIPS 203. For the receiving machine that all is external data. As described herein, at least part of the external data may be processed to establish a commonly shared n-state reversible inverter. This allows machines that don't know each other to share ad hoc a common secret inverter. Certain machines that collaborate regularly, may use pre-stored common data to generate a shared inverter. One may call this internal data.

The FLT as illustrated in FIG. 1 requires an n-state reversible inverter and its reversing inverter to create a modified version of an n-state operation that has different n-state outputs than the original unmodified n-state function, but maintains its meta-properties. Such meta-properties may be finite field properties. For cryptographic purposes, a preserved output distribution is of significance as it prevents creating a bias towards a certain output. For instance, in hashing operations such as SHA 256/512 and SHA3 and Blake and others, the steps of the work or data flow are such that the output of the hash, the hash value or hash, seems completely random. By a bias-free modification/transformation the bias free random appearance is maintained.

A hash is a one-way operation that is preferably NOT reversible. So, while for instance the addition mod-2\hat{ }32 as used in SHA256/512 is a reversible operation, one needs not replace it with a reversible operation, but preferably preserve its uniform or flat sum-space distribution under assumption of all possible input combinations.

Cryptographic hashing is used in many applications, including but not limited to: Digital Signatures: Widely used in RSA, ECDSA, and EdDSA schemes; TLS/SSL: Integral to certificate validation and handshake integrity; Blockchain: Bitcoin uses SHA-256 for block hashing and mining; Ethereum uses SHA-3 (Keccak); Password Hashing: Sometimes used (though not ideal alone); often combined with salting and key stretching. Software Integrity: Verifying file downloads, firmware updates, and package signatures. HMAC: Used in HMAC-SHA256 for message authentication in APIs and secure communications. SHA-3 (Keccak) Post-Quantum Cryptography: Considered more resilient due to sponge construction. Ethereum: Uses Keccak-256 (a variant of SHA-3) for address generation and smart contract hashing. Digital Signatures: Supported in newer schemes like SPHINCS+ and LMS. Secure Hashing in Hardware: Increasingly adopted in embedded systems and FIPS 202-compliant devices. BLAKE/BLAKE2/BLAKE3 File and Data Integrity: BLAKE2 is used in tools like Zstandard and Argon2 (password hashing). Cryptographic Libraries: Supported in libsodium, RustCrypto, and other modern libraries. Blockchain Projects: Some altcoins (e.g., Decred) use BLAKE-256 for mining. Password Hashing: BLAKE2 is used in Argon2, the winner of the Password Hashing Competition. High-Speed Applications: BLAKE3 is optimized for parallelism and used in performance-critical hashing.

One may compare the modifications with but differentiate it from stateful and stateless hashing as currently recommended and/or used. Stateful Hashing: Key, nonce, or other inputs evolve over time or between sessions. Maintains context or “memory” between operations, often requiring synchronization. Common in scenarios like: Merkle trees with sequential updates. Hash chains in password storage or one-time authentication tokens. Systems where per-message uniqueness is enforced (e.g. blockchains or voting protocols). It has higher entropy, more adaptive security, but requires careful tracking and may be vulnerable to state desynchronization. Stateless Hashing: Every invocation is functionally identical-same inputs, same output, regardless of time or context. Standard in SHA-2, SHA-3, BLAKE, etc. Customization (like a nonce or salt) must be explicitly included in the input data. It has simplicity, composability, easy verification, but is vulnerable to structural patterning unless external entropy is injected.

There are many digital signature methods for instance that may use different schemes for digital signature generation and verification. And more variants are added, like Dilithium and Sphincs+. While Sphincs+ originally recommended SHA-256 one is now recommended SHAKE-256 (which is a Keccack configuration).

SHA-2 as disclosed in NIST FIPS 180-4 Secure Hash Standard (SHS), 2015. It includes SHA-256 and SHA-512. SHS discloses the binary 2 operand functions that operate of words of w bits with w commonly being 32. Another function that is applied in SHS is addition mod-2\hat{ }w. Composite functions in SHS are Ch(x, y, z)=(xΛy)⊕(¬xΛz); Parity(x, y, z)=x⊕y⊕z; Maj(x, y, z)=(xΛy)⊕(xΛz)⊕(yΛz); Parity(x, y, z)=x⊕y⊕z. Another function that is applied may be represented as: ROTR 28(x)⊕ROTR 34(x)⊕ROTR 39(x), which is a rotation right of bits in words and XORing of these rotated words. Furthermore, in an initial (pre-processing) stage, an XORing with pre-set constants is applied. Furthermore, addition mod-2\hat{ }w is widely applied.

It may not be necessary to change all functions and all constants in all rounds. In fact, as SHA-256 has 80 rounds selectively changing these aspects in one or more rounds may have dramatic effects and by their sparse application (for instance 1 in 80 rounds) are much more difficult to predict or isolate, while the avalanche effect takes care of rapidly propagating changes into the generated hash. The following are some aspects that may be transformed in SHS: 1) Field-Level Arithmetic Modifications including substituting bitwise XOR/addition with reversible functions over finite fields, and modifying byte-level operations independently or compositionally. 2) Modular Addition Substitution, replacing addition modulo 2\hat{ }w with a computationally statistical equivalent but altered version (e.g., permutation-based adder). 3) Constants Modification, permute, replace, invert, or encode constants using secret or keyed transformations. Randomize constants per instance to produce polymorphic variants. 4) Boolean Function Rewriting, redefining operations like Ch, Maj, Σ0, Σ1 with functionally equivalent but syntactically modified variants. 5) Selective round-based substitution or dynamic morphing per hash invocation. 6) State Initialization and Scheduling Variants, Rewriting the message schedule logic or bit-mixing step. Tweaking state initialization values. 7) Structural and Topological Transformations, Changing the round permutation order, iteration depth, or compression layering. 8) Contextual Control Key-based, nonce-based, or external-parameter-driven transformation selection. 9) Controlled randomness to induce instance-specific obfuscation, and 10) Execution Environment Coupling, Binding transformation logic to runtime or hardware fingerprinting data (e.g., trusted computing base, memory layout, etc.)

One may be concerned about processing 32-bit words and how to invert a 2\hat{ }32-state element or create a 2\hat{ }32-state reversible inverter. A simple, consistent approach is to split a 32-bit word in 4 8-bit words or the 64-bit word in SHA-512 in 8 8-bit bytes. Instead of performing the XOR one then applies an addition over GF(256) to each pair of corresponding bytes in a word of 32 or 64 bit, respectively. One may apply the same FLTed or 256-state inverter modified addition for each combination of bytes or 256-state elements. If one desires one may use 2 or up to 4 in 32-bit or up to 8 in 64-bit word operations.

For convenience and consistency, one may divide a sequence or 32 or 64 or any number of bits in equal sized sub-words. That is not a requirement for cryptographic purposes as the FLT maintains the inherent statistical distribution of operation outcomes. One may divide a 32-bit word into 1 word of 7 bits, one word of 9 bits, one word of 10 bits and one word of 6 bits. The smaller number of variations associated with smaller words is offset dramatically by the increased number of variations in the larger numbers, especially because different numbers of bits require different FLTs. One may of course also apply an n-state method of large words of bits, like 32-bits or 256-bits or larger, as disclosed herein above.

One may use “rule based” inverters. For instance, inv(x)=a*x+b mod−n is such a rule based inverter that may be applied for individual inversions as well as for individual reversing inversions. These rules, while useful, are also somewhat predictable and an attacker with large processing capacity may try brute force. One effective method is to use an n-state maximum length (ML) Feedback Shift Register (FSR) as described in U.S. patent application Ser. No. 18/741,663 to Peter Lablans, filed on Jul. 20, 2024, entitled N-state Maximum Length-Feedback Shift Register (ML-FSR) Based Cryptographic Machines, which is incorporated herein by reference. The implementation as an p k-state FSR with p k-state register elements and k-state feedback functions make it very effective, fast and configurable. The ML-FSR with an initial content is run for q cycles, creating a new FSR content which is the inverted element. By constructing a reversing FSR one can recover the original content by running the reversing FSR also for q cycles. The content in bits is p*k. A 32-bit reversible inverter may be constructed from an 256-state FSR having 4 256-state (8 bits) shift register elements. The number of different ML-FSR states in that case is of course 256\hat{ }4−1, with the zero-state being processed onto itself. It is shown in the patent application that one can FLT the ML-FSR based on a 256-state reversible inverter, which makes brute force attacks on that type of inversion infeasible.

In SHA-3 a state array A is defined as 1600 bits sequence arranged in a 5 by 5 by 64 array. This array is processed in several steps in several rounds (like 24 rounds) as taught in FIPS 202. In accordance with an aspect of the present invention one may modify all or part of the 1600 bits with an n-state inverter with n greater than 2 and preferably 5 or greater. One may invert elements of the 1600 bits, for instance as bytes, with a 256-state inverter. One may invert parts of the 1600 bits, for instance as lanes of 64 bits or 8 bytes or as modified rows or columns in slices of the array. One may also invert a word of 5 bits or invert all the bits in a slice as a set of 5 5-bits words with a 5-state inverter or invert a 25-bit word with a 2\hat{ }25-state inverter. Or invert any series of bits in the state A by an n-state inverter. Preferably one performs the modification in an early round of total rounds, preferably in a round before the ¾ mark is reached and more preferably before 50% of the rounds is reached. The reason being that in that case the avalanche effect can do its works and diffuse the effect of the changes over the state array.

One may apply a permutation or shuffle to elements of the 1600 bits. One may shuffle all 1600 bits with a 1600-state inverter. Preferably at least once during processing. One may also apply it to a lane with a 64-state inverter or to any selection of bits in the 1600 bits. One may also divide a series of bits into k-state elements, like a lane of 64 bits into a sequence of 8 bytes and shuffle the bytes with an 8-state inverter. A more effective way may be to take 9 7-bits words of 64 bits of the 1600 bits and shuffle them with a 9-state inverter and then divide the shuffled 64 bits into a sequence of 8 bytes and inverter the bytes with a 256-state inverter. One will understand that these are merely examples of ways to invert words of bits and shuffle sequences of bits and that many different modifications based on reversible inverters are possible and fully contemplated. One may process these bits by inversion and/or shuffling before or after one of the 5 step mappings as they are called in FIPS 202 are applied.

As an illustrative example, the inventor did run the chi mapping step through all its possible inputs and found that it performs as a 32-state reversible inverter, characterized in Matlab as: inv32=[1 6 11 12 21 18 23 24 10 13 4 3 14 9 16 15 19 22 25 28 7 2 5 8 27 30 17 20 31 26 29 32]. Matlab using origin-1 for indexing, while SHA-3 uses index origin-0. One should adjust for that. The inventor further applied a publicly available Matlab implementation of SHA-3 available from https://www.mathworks.com/matlabcentral/fileexchange/71760-sha-3-hash by David Hill (“Hill”) posted on Dec. 25, 2019, including the functions code at subpages which are all incorporated herein by reference. The chi.m program in Hill follows the FIPS 202 specification. The inventor replaced the chi.m code with the above 32-state inverter, with proper adjustment for index as well as conversions between binary and decimal 32-state representations.

Checking it an a standard ‘hello world” message on a public SHA-3 website it turned out that the use of the inv32 inverter generated the correct 512 bit hash which is: digest1=SHA3(‘hello world’, 512) % or 224, 384, 512 depending on the output length you want ‘840006653e9ac9e95117a15c915caab81662918e925de9e004f774ff82d7079a40d4d27b1b 372657c61d46d470304c88c788b3a4527ad074d1dccbee5dbaa99a’.

Next the inventor split the Keccak.m function which executes the Round function 24 times, into ir=0:10 A=RND(A,ir); ir=11:11 A=RND1(A,ir); and ir=12:23 A=RND(A,ir). Herein in RND1.m the original inv32 is replaced by inv32a=[25 29 7 13 16323121 17 1 1029302824 182027 542223 11 8 142663 12 19 15]. This creates the new hash digest2=‘840006653e9ac9e95117a15c915caab81662918e925de9e004f774ff82d7079a40d4d27b1b 372657c61d46d470304c88c788b3a4527ad074d1dccbee5dbaa99a’. The Hamming distance between digest1 and digest2 is 263 which is about 256 (or ½ of 512) which confirms the preservation of the avalanche effect and indicates cryptographic security.

It is just one possible modification. In order to let the avalanche effect of the architecture of SHA-3 do its work one should preferably create the modification a limited time and limited rounds before about ¾ part of the last round. In SHA-3 that is before round 19 or 18. One may use different 32-state inverters (of which there are factorial of 32 (32!)) for different rounds or the same modified inverters.

In many applications one applies light weight encryption. Light weight here is usually 128 bit keys and at least 122 bits of security. An example is ASCON which has been published by NIST as SP.800-232. These lightweight cryptographic methods provide secure encryption that can run relatively fast on processing constrained devices. Other lightweight encryption is well known and may include: AES-128, Speck, Simon, Hummingbird, Twine and Katan for instance. Details of these methods are easily found on line. A collection of lightweight cryptography methods is provided on NIST webpage https://csrc.nist.rip/Projects/lightweight-cryptography/round-1-candidates which is incorporated with all its descriptive files herein by reference.

One example of a lightweight cryptographic application is Ascon. Ascon provides authenticated encryption, fixed-output-length hashing, and an eXtendable Output Function (XOF) to generate sequences of variable length. The original submission also included a post-quantum variant (Ascon-80pq), which is not part of the final NIST standard. Additionally, a 64-bit key version was proposed by the original developers but excluded from the NIST specification. The Ascon permutation function consists of three layers: a bitwise substitution layer (using a 5-bit S-box), a linear diffusion layer (using rotations and XORs), and a constant-addition layer. Operations are performed on a 320-bit internal state, represented as five 64-bit words.

It was already explained that FLT and CFT may increase security dramatically of for instance encryption like AES and ChaCha20 and variations thereof. Possible to a solution space 10\hat{ }500 or greater. Lightweight cryptography is presented as a solution for resource constrained devices that require at least some form of cryptographic security. Another view is that size and price both of memory and processors has developed such that including transforms as disclosed herein increases security while only increasing size and price marginally or not at all. In fact, the transformations allow a lightweight cryptographic method of a puny 84 bit security or a decent but minimal security of 128 bit to a dramatically increased level. A differentiator of a lightweight method is often the speed it works with. Generally faster than the heavyweight methods like AES and ChaCha20.

The lightweight methods have sufficient “transformation points” that allow to implement security enhancing methods and ways disclosed herein. A transformation point in a cryptographic method is a datapoint or a function that may be transformed in a manner as described herein. In Ascon, as an illustrative example, there are several ways. 1) transform the key and nonce. Assuming size of 128 bit which is 16 bytes one can concatenate and then shuffle all bits with a 256-state inverter or invert the bytes or other word size. 2) one may either invert or shuffle the 320 bit state with appropriate inverters. 3) one may invert or shuffle the S-box of 32 5-bits elements with an appropriate 32-state inverter; and 4) one may FLT or transform the bitwise XORing of words of 64 bits, for instance by considering them as words of 8 bytes and the combining as addition over GF(256) of 256-state elements and transform the addition in accordance with an inverter. This is one set of modifications and other transformations are possible and fully contemplated and may include resizing of words of bits.

One may desire to maintain speed of Ascon over processing a message and applying all possible modifications for all steps and all rounds may not be beneficial to maintain overall processing speed. One may program to modify only one or limited number of steps per round. By using one or more self-propagating inverters one may vary the modifications per modification. Furthermore, one may create a Just in Time (JIT) structure where a modification is assigned its own processor or processing core that generates a particular modification or modified table while a main processor is performing the steps of the base Ascon architecture. Such an approach ensures that a modification is only computed when it is needed and does not require pre-computation or pre-storage. It creates an Ascon architecture that is unchanged but with a dynamic Just-in-Time implementation that performs a modified Ascon in the same time or close to the same time as the unmodified Ascon but with a much higher security then its initial key size seems to imply and with exceptional speed.

One may use Ascon XOF itself to expand an initial key to required length for an n-state reversible derived reversible inverter. Ascon generates state updates in a one way manner with repeatability at transmission and receiving side.

Ascon is used herein as an illustrative example. In accordance with one or more aspects of the present invention one may apply one or more of the transformations herein to revive cryptographic methods that are currently considered broken.

Combinatorial explosion increases the number of possible implementations of n-state computer functions. This renders known algebraic or reasoned attacks infeasible. One is reminded that it still leaves open brute force attacks. The agility of the herein disclosed methods or approaches allows to create transformations that modify attackable output per output unit. So, a ciphertext outputted in blocks of 128 bits, if one transforms dynamically, requires each block to be broken by brute force per block, as breaking a previous block is largely irrelevant to a new block.

The inventor may be his own lexicographer. One term used herein is the term Finite Lab Transform or FLT. This means a 2-operand n-state operation is modified as explained in FIG. 1. The FLT may be implemented as such with the n-state inverters. One may also for convenience create a lookup table that represents the outcome of an FLT by using all possible input operands. This makes an implemented FLT extremely fast. One may then call the result of applying the FLT an FLTed function or FLTing a function.

A function herein is a computational function realized by physical elements. While being represented as a table or even mathematical expressions, all functions herein still are computer functions. A computer function is a discrete switching function that is characterized by an n-state table with n=2 when the operation is called binary or n>2 for other operations. These functions are in accordance with the Blaauw framework, described as an expression but executed by a physical device. Thus, any computer function herein maps directly to a physical device.

The Finite Lab-Transform or FLT is a patented invention by the inventor of the aspects of the present invention. It is extensively described in U.S. patent application Ser. No. 18/097,396 filed on Jan. 16, 2023, which is incorporated herein by reference. It was also disclosed in U.S. patent application Ser. No. 15/442,556 files on Feb. 24, 2017 and issued on Dec. 24, 2019 as U.S. Pat. No. 10,515,567which are both incorporated herein by reference.

All numerical examples have been executed in working computer programs, most in Matlab. Providing a large reversible inverter is confusing by its size and only its beginning and ending may have been included as illustrative example. However, a Dell Computer on which an old version of Matlab was installed had no problems in rapid execution, in that case using a stored look-up table. One of ordinary skill is able to repeat the computations based on the details provided herein.

For convenience the computer language Matlab has been applied in demonstrating aspects of the present invention. This Matlab language is close to pseudo-code and easy to understand for one of ordinary skill. However, all aspects are implementable in other computer languages, including Machine Language, Assembly Language, Interpreted Languages and Compiled Languages. This may include C, C++, Java, Python, Rust, Mathematica, Go, C#, Ruby, Magma as illustrative but non-limiting examples.

Matlab is known for its speed in array or matrix processing. However, Matlab's array indexing works from starting index 1 (origin-1) instead of index 0 (origin-0). This is by itself not an issue and actually illustrates that the computations performed in Matlab using lookup tables or otherwise implemented switching tables have no inherent mathematical meaning, but are only meaningful in providing a state transformation, which is a machine property.

Herein operational functions and/or data in a cryptographic method and/or device are transformed in accordance with preferably a reversible n-state inverter. The reversibility of the n-state inverter ensures that the transformation does not introduce a detectable change in the cryptographic output. This has been checked with for instance measuring Hamming distance between cryptographic outputs such as hash and/or ciphertext based on identical plaintext or input data with different transformations. No significant indications in for instance Hamming distance between the modified results reveal a change.

The FLT preserves that the transformed addition over GF(n) is also an addition over GF(n). So, when applied in for instance AES-GCM and keeping the FLT secret, it increases security while preserving a proven mathematical structure. The important aspect, based on analysis, is if modification in switching functions and/or data transforming devices substantially modify the statistical make-up of the output of these devices. These transformations leave the output generally with a random character that make them statistically indistinguishable from unmodified functional methods and/or devices. The most important property in one aspect is that a changed function or data doesn't change the statistical make-up of the output.

One may apply a replacement of a function either by changing the base function or transforming the base function that leaves the statistical properties of being random without a bias unchanged. A first requirement is that a function has to have a flat or uniform sum-space as defined earlier. This has as consequence that function doesn't have to be an addition over GF(n=2\hat{ }k) in the binary case, as in replacement of bitwise XORing of k bit words. It means though that an addition over GF(n=2\hat{ }k), as an illustrative example, must be replaced by a reversible n-state function to keep random performance intact or largely intact so that the replacement or transformation cannot be detected in the output data.

One may select a base function that cannot be created by an FLT of another function. For instance, one may use for n=8 the novel 2-operand involution si8=[1 2 4 3 5 6 8 7; 2 1 3 4 6 5 7 8; 4 3 2 1 8 7 6 5; 3 4 1 2 7 8 5 6; 5 6 8 7 1 2 4 3; 6 5 7 8 2 1 3 4; 8 7 6 5 4 3 2 1; 7 8 5 6 3 4 1 2] which is not an addition over GF(8). This specific involution constructed by the inventor, generates 5040 different variations from 40,320 different 8-state reversible inverters, or (n−1)!. Using a partial FLT only inverting the inputs one gets 10,080 different variations, or 2*(n−1)!. Using the partial FLT with only transforming the output, generates 40,320 or n!different variations. Yet, another replacement is using an addition mod-n table or a variation (like FLT) thereof as a base function. Similarly, one may use a function subtraction modulo-n as a replacement for the base function addition over GF(n). All these replacements generate at least (n−1)!variations. Furthermore, one may use a transformation like an FLT or partial FLT as the base function, making successful attacks yet more difficult.

The inventor has previously disclosed novel and non-obvious n-state involutions for n=2\hat{ }k that are not additions over GF(n=2\hat{ }k). This is taught for instance in U.S. patent application Ser. No. 18/750,970 to Lablans, filed on Jun. 6, 2024 and incorporated herein by reference. These methods are after disclosure in one or more patent applications also described in the open literature and easily available to one of ordinary skill.

A functional modification, replacement or transformation is mostly different in that in most cases significant operational properties are preserved and thus fundamentally does not modify the probability of the performance. Many cryptographic operations, including hashing such as SHA-256/512 applies multiple constants, that may be called K-constants. In one embodiment one may modify and/or replace one or more constants in one or more rounds. A K-constant is 32 bit long and one may for instance shuffle a K-constant with a 32-state inverter or consider a 32-bit word a set of 4 256-state elements (or bytes) and invert these with a 256-state inverter, for one or more rounds. Preferably for at least one round. or for just one round.

The transformations herein and variations thereof may be applied to existing cryptographic machine operations, such as defined by standards such as NIST FIPS, Internet RFC, OIS and other cryptographic standards. They may also apply to modifications that change a base architecture of a cryptographic process. For instance, one may generate a key-stream by way of an FLTed n-state feedback shift register (FSR). This may be implemented as an array-vector multiplication, benefiting from existing array processing standard processing libraries. One may also apply a keystream generator created by a dynamically changing hash like SHA 256/512 or SHA-3 or other.

One may modify the cryptographic operations in packages like libcrypto to implement the CFT aspects as disclosed herein.

While for efficiency one may use one common PKI based key, one may preload other keys that may be applied or install a PKI procedure that creates at least 2 common secure keys and potentially common n-state inverters. In the alternative one may also modify a seed n-state inverter generation process to create a different n-state inverter from the same expanded sequence or use a different expansion procedure.

Speeds of 50 ns per block are achievable. A typical ACH transactions (like direct deposits or bill payments) typically range from a few KB to tens of KB. And wire transfers contain more detailed information but still usually stay within hundreds of KB. Even blockchain transactions stay generally with 100 kB size. For transactions that require ultra-high security, the above dynamically changing keystream generation would be applicable. Other variations may be applied, including modification of combining functions in encryption/decryption steps.

FIPS documents are Federal Information Processing Standards issued through the National Institute of Standards and Technology in Maryland. NIST also issues Special Publications which are recommendations on cryptography. It is assumed that one of ordinary skill in the art of cryptography is familiar both with the content of FIPS and SP documents issued by NIST. These known documents include FIPS 180-4, FIPS 186-4, FIPS 197, FIPS 202, FIPS 203, FIPS 204. Furthermore, NIST Special Publications SP 800-38A SP 800-38B, SP 800-38C, SP 800-38D, SP 800-38E and SP 800-38F. ChaCha20 is fully described in for instance RFC 7539. Other standards in Cybersecurity as well as their implementation in software such as OpenSSL, Microsoft CNG, Apple CryptoKit, and Bouncy Castle are widely known and well documented. Even if a PHOSITA has no detailed knowledge of a particular standard or implementation, these are available for perusal on-line. As such, access to the details of cryptographic standards and computer implementations, while possibly time consuming, does not create undue experimentation.

In case any text provided herein is different from documents incorporated herein by reference, the instant specification is to be relied upon over prior documents.

In accordance with an aspect of the present invention, modified cryptographic operations as taught herein are applied in cryptographic agility applications. Current persistent attacks by cyber criminals as well as other threats to security have created a need for what is called cryptographic agility (Crypto Agility). This requires a quick smooth and reliable switch between for instance different cryptographic primitives and/or Key Encapsulation Mechanism (KEMs). Supposedly, this will throw off cyber attackers and increase security. It is believed that current proposals for Crypto Agility are too complex and will not create long term security. The cryptographic solutions as provided in the instant document allow for smooth parameter based configuration of a single cryptographic primitive. These transformation-based modifications create immensely large solution spaces, are simple to implement and based on agile implementation of parameter driven configurations.

Depending on requirements of security, one may want to transform a computer function like an addition over GF(n) or an n-state involution or other, on a message or session level, or more granular, like a packet level, a message block level, a round level, and/or a word level. The inventor has experimented with Matlab, C and Python up to round level and block level modification. As far as the inventor could check, the modifications are relatively simple and easily performed and extremely fast, especially when look-up tables are applied. Using Matlab tic-toc execution instruction elapsed time of program execution is transformed LUTs are faster than standard word XORing. Furthermore, the structure of rounds and blocks provides sufficient time for a processor or processor core to determine a next n-state reversible inverter to enable a novel and different transformation. The transformation itself as best understood does not form a bottleneck for the processing of a cryptographic process. Thus, if a cryptographic process in its unmodified state runs real-time, its modified or transformed version will also real-time. Real-time herein means that a processing of a message is not limited by a cryptographic operation.

Many files or messages are cryptographically processed in bulk in its entirety and may experience some delay before being transmitted. Application of the transformation does not affect the user experience. In the classical sense of real-time processing is the processing of a discrete sample of a sample at a speed that complies with the Nyquist criterion for signal reconstruction. This applies to realtime block and packet encryption/decryption, wherein the encryption and/or decryption of transformed computer functions does not create unwanted delay. Tests and analyses strongly suggest that no unwanted delays are created in round or block or packet level encryption decryption. Thus, realtime transformations are achieved.

The inventor herein applies the architecture/implementation/realization framework of his late Professor Dr. Gerrit A. Blaauw. However, Dr. Blaauw applied a common architecture over different generations of realization and implementations to retain compatibility of output over different generations of computers. The inventor retains a common architecture or data flow for instance of AES-GCM, because the strength and security (confusion and diffusion). But the inventor changes or transforms the implementation of functional parts that leave the data flow or architecture intact, but drastically changes its output. The inventor enables an immense variation space (about 10\hat{ }500 for n=256) based on novel transformations and combinatorial explosion. In that sense the current approach is significant different from the Blaauw framework in that it deliberately prevents commonality in implementation (rather than maintaining it) while preserving a proven and tested architecture.

Herein the term carry function and borrow function and n-state carry function and n-state borrow function are used. These terms are often used in the context of radix-n addition and subtraction or ripple carry operations. These functions may be transformed and are called transition functions. The transition function determines an output or transition element based on 2 n-state operands from different words of operands, each word preferably having 2 or more n-state operands. The input operands are preferably selected from corresponding positions in the two words. The output of the transition function is a transition element and is processed in a next position of operands in a result word, which may be an intermediate word. When corresponding residue functions are derived from an addition over GF(n) or from an addition modulo-n or from a commutative n-state involution, one may call the transition function a carry function and the output an n-state carry. An operation that reverses such operations may be called a subtraction and the transition function may be called a borrow function and the transition element an n-state borrow element. It should be clear that the function being an addition or subtraction in the context of cryptography especially as it relates to commutative involutions may be irrelevant as subtraction and addition are the same. The carry and borrow become relevant when a radix-n operation needs to be reversed. For one-way operations such as keystream generation there is no relevance in naming difference.

While there have been shown, described and pointed out fundamental novel features of the invention as applied to preferred embodiments thereof, it will be understood that various omissions and substitutions and changes in the form and details of the device illustrated and in operation may be made by those skilled in the art without departing from the spirit of the invention.

1. A computing device, comprising:
a memory configured to store data including instructions;
an input enabled to receive external data generated by a transmitting computer device over a physical transmission channel;
a processor enabled to retrieve instructions from the memory and to execute the instructions to perform the one or more steps of:
implementing an n-state reversible inverter derived from at least part of the received external data or from data internal to the computing device, with n an integer greater than 3; and
processing at least part of the received external data with a cryptographic operation selected from the group consisting of a decryption, a hashing, and a sequence generation, wherein the cryptographic operation includes an n-state computer operation based on the n-state reversible inverter.

2. The computing device of claim 1, wherein a binary cardinality of the n-state reversible inverter is greater than a binary cardinality of data it is derived from.

3. The computing device of claim 1, wherein the n-state reversible inverter is generated derived from a Public Key Infrastructure (PKI) key, shared with a sending computer.

4. The computing device of claim 1, wherein:
the n-state computer operation is an n-state 2-operand commutative involution with n=2\hat{ }k and the n-state computer operation is not characterizable as an addition over finite field GF(n=2\hat{ }k) with k an integer greater than 1.

5. The computing device of claim 1, wherein the n-state reversible inverter is applied in a Finite Lab Transform of a computer function that has at least 2 input operands.

6. The computing device of claim 1, wherein the n-state reversible inverter is implemented in an n-state array-vector multiplication derived from an n-state Maximum Length (ML) Feedback Shift Register (FSR).

7. The computing device of claim 1, wherein the n-state computer operation is a 2 operand operation, each operand being represented by a word of two or more n-state elements and the n-state computer operation includes an n-state reversible residue function and an n-state transition function and the n-state transition function is configured to switch between at least three distinct states.

8. The computing device of claim 1, wherein the n-state reversible inverter is based on a p by p array of k-state elements and k\hat{ }p=n with k and p integers and k greater than 3 and p greater than 1.

9. The computing device of claim 1, wherein the n-state reversible inverter is based on a p by p array of k-state elements and n is prime with n=k\hat{ }p+q with k, p and q integers and k greater than 3, p greater than 1 and q at least 1.

10. The computing device of claim 1, wherein the n-state reversible inverter is a seed inverter of a self-propagating reversible inverter.

11. A computer implemented cryptographic method, comprising:
receiving by the computer from a physical transmission channel external data;
implementing by a processor an n-state reversible inverter derived from at least part of the external data, with n an integer greater than 3;
processing by the processor of at least part of the external data with a computer implemented cryptographic operation selected from the group consisting of a decryption, a hashing, a sequence generation, wherein the cryptographic operation includes an n-state computer operation based on the n-state reversible inverter; and
generating data, derived from at least part of the external cryptographic data, and the data being selected from the group consisting of decrypted data, a hash, a shared PKI key, and a verification of a digital signature.

12. The method of claim 11, wherein a binary cardinality of the n-state reversible inverter is greater than a binary cardinality of data it is derived from.

13. The method of claim 11, wherein the external data includes Public Key Infrastructure (PKI) data.

14. The method of claim 11, wherein the n-state reversible inverter is generated derived from a Public Key Infrastructure (PKI) key, shared with a sending computer.

15. The method of claim 11, wherein:
the n-state computer operation is an n-state 2-operand commutative involution with n=2\hat{ }k and the n-state computer operation is not characterizable as an addition over finite field GF(n=2\hat{ }k) with k an integer greater than 1.

16. The method of claim 11, wherein the n-state reversible inverter is applied in a Finite Lab Transform of a computer function that has at least 2 input operands.

17. The method of claim 11, wherein the n-state reversible inverter is implemented in an n-state array-vector multiplication derived from an n-state Maximum Length (ML) Feedback Shift Register (FSR).

18. The method of claim 11, wherein the n-state computer operation is a 2 operand operation, each operand being represented by a word of two or more n-state elements and the n-state computer operation includes an n-state reversible residue function and an n-state transition function and the n-state transition function is enabled to assume at least 1 of 3 states.

19. The method of claim 11, wherein the n-state reversible inverter is based on a p by p array of k-state elements and k\hat{ }p=n with k and p integers and k greater than 3 and p greater than 1.

20. The method of claim 11, wherein the n-state reversible inverter is based on a p by p array of k-state elements and n is prime with n=k\hat{ }p+q with k, p and q integers and k greater than 3, p greater than 1 and q at least 1.
